(19) United States
(12) Patent Application Publication
(10) Pub. No.: US 2019/0358595 A1
(43) Pub. Date: Nov. 28, 2019

(54) MIXING/AERATING APPARATUS WITH AN IMPELLER

(71) Applicant: AQUASYSTEMS INTERNATIONAL N.V., Halle (BE)

(72) Inventor: Johny Haegeman, Halle (BE)

(73) Assignee: AQUASYSTEMS INTERNATIONAL N.V.

(21) Appl. No.: 16/532,709

(22) Filed: Aug. 6, 2019

Related U.S. Application Data
(63) Continuation-in-part of application No. PCT/BE2017/000015, filed on Feb. 10, 2017.

(51) Int. Cl. B01F 3/04; B01F 7/00; B01F 13/00

(52) U.S. Cl. CPC B01F 3/0478; B01F 7/00341; B01F 13/0049; B01F 7/00416

(57) ABSTRACT

An improved mixing apparatus for mixing a liquid within a liquid body is provided. Generally, the improved mixing apparatus may comprise: a supporting element (1) with a partly conical volute with an upper corrugated free edge; a top-mounted power drive (2); and an impeller (4) mounted on said shaft (3) for rotation therewith.

### CROSS-REFERENCE TO RELATED APPLICATION

The present application is a continuation-in-part application of PCT/BE2017/000015 entitled “MIXING/AERATING APPARATUS WITH AN IMPELLER AND SCREW CENTRIFUGAL IMPELLER,” filed on Feb. 10, 2017 and published on Aug. 16, 2018 under number WO 2018/145171.

### BRIEF DESCRIPTION OF THE INVENTION

The invention relates to an apparatus for at least mixing a liquid within a liquid body, said apparatus comprising an impeller extending at least partly within a housing provided with an upper corrugated free edge, with a peak—bottom distance of at least or equal to 2 cm.

### THE STATE OF THE ART

A state of the art apparatus for mixing a liquid within a liquid body is disclosed in U.S. Pat. No. 4,468,358 using a screw centrifugal impeller.

Other state of the art apparatuses are disclosed in U.S. Pat. Nos. 2,346,366; 3,416,729; 3,669,422; 3,735,926; 3,797,809; 3,865,909; 3,871,581; 4,093,401; 4,193,951; and 4,482,510 generally using a propeller type impeller, the content of which is incorporated herein by reference.

With all such apparatuses operated as surface aerator, the flow of liquid expelled outwardly of the volute or housing having a flat upper edge (extending substantially within a horizontal plane) is equally distributed over the single central float, and well above the liquid level.

DE2408794 and EP0818422 relates to apparatuses for sucking floating foam and for directing said foam downwards, said apparatuses being not able to pump liquid from the bottom of a housing and to expel it at the top of the housing.

Aeration and mixing in liquid more specifically waste waters, are energy consuming systems. Obviously, it is still a major challenge for designers and inventors to find solutions to reduce this energy consumption to a minimum for a given mixing and oxygen input. They have not only to find the most efficient design as such, but also to provide the means to adapt the apparatus to the given application and basin geometry.

To reach that goal for an apparatus as a surface aerator, the inventor has found that the apparatus should pump up the liquid through a volute or housing with an upper edge close to or at the liquid body surface and not higher as done with the state of the art apparatuses, because the pumped up liquid has anyway to return to that liquid surface.

Furthermore, the inventor has found that the position of the flat upper edge of the volute or housing close to or at the liquid level is very important for maximizing the induced flow in the liquid body which is necessary to create a mixing pattern that distributes the entrained air throughout the liquid body. Indeed, with the edge of the volute or housing close to or at the liquid level, the spray returns very close back to the liquid surface and fully accelerates the induced flow and thus the rapid renewal of the surface layer.

However, with the actual design of all existing state of the art apparatuses with a cylindrical, conical and/or flared out volute or housing having an upper edge substantially flat. The operation in that position close to or at the liquid level is very unstable and/or unpredictable, possibly as a mixer and/or as aerator. To obtain a quite stable operation with the said existing apparatuses working as an aerator being fixed or floating, the flat edge of the volute or housing has to be positioned well above the liquid level. The spray returns much further away from the volute or housing back to the liquid body surface. As most of the state of the art apparatuses use a single central float, having an upper edge significantly above the liquid body surface for buoyancy, the spray must go over the float upper surface, and the spray returns even further away from the volute or housing back to the liquid body surface. The trajectory of the spray is unnecessary long for bringing this primary flow to saturation. Also, the spray loses velocity before hitting the liquid body surface (both the horizontal and vertical velocity vectors being reduced when hitting the liquid body surface) on one hand and part of the induced flow returns to the intake cone on the other hand. Consequently, the lower end of the impeller must be positioned sufficiently deep in the liquid together with a sufficiently long volute or housing to pump up a full flow, resulting in a long screw part for a screw centrifugal impeller or a long shaft for a propeller. It means thus also for such known apparatuses used as aerator, a reduced mixing and aerating capacity for a given power consumption.

To obtain a more stable operation with the existing apparatuses operated as a mixer with little or no aeration (apparatuses being fixed of floating), the flat upper edge of the volute or housing has to be positioned well below the liquid level, because if operated with the upper flat edge close to the liquid body surface, it has been observed an unstable and/or unpredictable operation, possibly as an aerator and/or as a mixer. Consequently, the goal as set forward above cannot be reached with the state of the art apparatuses.

Now, it has been observed that a stable operation or working or a more stable operation or working at any position substantially above and below and in between and especially close to or at the liquid body surface could be achieved with embodiments of apparatus of the invention.

It has also been observed that by controlling the outwardly flow of liquid, it was possible to generate different liquid flows in and out the liquid body, whereby enabling a better liquid waste treatment, a better aerating, a better foam treatment and/or a better mixing.

### BRIEF DESCRIPTION OF THE INVENTION

The invention relates to an improved mixing apparatus or mixing and aerating apparatus for a liquid within a liquid body, such as in a pool or basin (natural or artificial), said apparatus being, depending on and adapted to the application and basin geometry, less power consuming, while ensuring the same mixing/aeration achieved with the known apparatuses based on screw centrifugal impeller of U.S. Pat. No. 4,468,358 and other state of the art apparatuses based on a propeller, or with a same power consumption, said apparatus ensures a better mixing and aeration of the liquid than these known apparatuses.

The invention relates to an improved apparatus for at least mixing a liquid within a liquid body, said apparatus comprising:
A supporting element (1);
A top-mounted power drive (2) mounted on said supporting element (1), said power drive having a rotatable shaft (3) extending downwardly toward the surface of said liquid body;
An impeller (4) mounted on said shaft (3) for rotation therewith;
Possibly, but advantageously, at least one deflecting means selected from a static deflecting plate (5) attached to the supporting element (1), and a deflecting disc (8) associated to the impeller (4) or to the shaft (3);
An at least partly conical housing (6), said housing comprising at least an upper portion (6A) ending with an upper free edge, and a lower portion (6B) ending with a lower free edge, whereby said at least partly conical housing (6) is attached to an element selected from the group consisting of the supporting element (1) and a part attached to the said supporting element (1), whereby said at least partly conical housing (6) defines an inner open channel (6C) between an upper opening and a lower opening, said inner open channel of the at least partly conical housing (6) having substantially a central axis, whereby defining at least a first substantially circular cross section perpendicular to said central axis adjacent to the upper opening and a second substantially circular cross section perpendicular to said central axis of symmetry adjacent to the lower opening, said second substantially circular cross section being greater than the said first substantially circular cross section;

Whereby the impeller (4) has at least a lower portion (4B) extending at least partly within the housing (6) and, advantageously when the impeller is of a screw centrifugal impeller type, an upper portion (4A) extending at least partly outside the housing (6), said impeller (4) being adapted so that the rotation thereof is able to generate a pumping of liquid within the housing (6) through its lower opening, and to expel said pumped liquid through the upper opening of the housing (6), before being at least partly deflected by contacting the deflecting plate (5) and/or the deflecting disc (8), and

Whereby the upper portion (6A) of the housing or volute (6) has a corrugated upper edge defining peaks and valleys, two successive peaks being separated by a valley, while the distance measured parallel to the axis of the housing or volute (6) between the top of a peak and the bottom of a valley is at least 2 cm or equal to 2 cm, advantageously from 5 to 50 cm, preferably from 10 to 30 cm. Said upper corrugated edge working with the deflecting plate (5) and/or the deflecting disc (8) are adapted for achieving, at least when the peaks of said corrugated upper edge are partly above the liquid body surface and the valleys are partly below the liquid body surface, a quite flat liquid spray above the liquid body surface, with two or more than two distinct and separated quite stable spray points or zones.

Advantageously, the upper portion (6A) of the housing or volute (6) has a corrugated upper edge adapted to work with the deflecting plate (5) and/or the deflecting disc so as to enable to achieve, at least when the peaks of said corrugated upper edge are partly above the liquid body surface and the valleys are partly below the liquid body surface, a quite flat liquid spray above the liquid body surface, with three or more than three distinct and separated quite stable spray points or zones.

The number of distinct quite stable spray points or zones can be 4, 5, 6 or 7, or even more. The number is preferably an odd number, like 3, 5 and 7. The number of quite stable spray points or zones will depend from the number of valleys of the upper corrugated edge, two peaks being separated by a valley.

In function of the working of the impeller, the quite stable flat spray points or zones are characterised by a predetermined horizontal flow velocity at the liquid body surface, while two successive quite stable flat spray points or zones are separated the one from the other by a spray zone which is less flat and/or with a horizontal flow velocity at the liquid body surface lower than the said predetermined horizontal flow velocity for the quite stable flat spray points or zones.

When adapting the position of the upper edge with respect to the liquid body surface, the position of the stable flat spray zones can be adapted with respect to the axis of rotation of the propeller. The top level of the spray escaping from the volute or housing can also be adapted so as to reduce the height or size of the zone in which no or a low amount of expelled liquid falls.

For example, in some preferred embodiments, some radial liquid zones are zones with low or reduced flow rate or with substantially no flow rate.

By controlling the radial flow rate zones or the maximal speed of radial zones, with respect to flow rate or maximal speed for other radial zone, it is possible to have a better control of the stability of the apparatus, while operating, especially of a floating apparatus.

Preferably in the apparatus of the invention, the free upper corrugated (possibly outwardly flanged or flared) edge of the housing (6) extends between an upper plane perpendicular to the central axis of the housing (6) and a lower plane perpendicular to the central axis distant from the said upper plane by a distance of at least 2 cm, advantageously by a distance comprised between 5 and 50 cm, preferably between 5 and 25 cm.

Preferably, the free upper edge has a series of peaks and a series of valleys having each a bottom, whereby two successive peaks are separated the one from the other by a valley with a bottom, whereby each of the said peaks extends advantageously within the said upper plane, and/or whereby each bottom of the said valleys extends advantageously within the lower plane.

Most preferably, the peaks and valleys are located within a partly cylindrical upper portion of the housing, whereby when developing the said partly cylindrical upper portion of the housing in a developing plane, the peaks and valleys are at least partly curved.

According to a detail of a preferred embodiment, the free upper edge comprises from 2 to 10, preferably from 3 to 9 peaks, most preferably 3, 5, 7 or 9 peaks.

Especially, when developed within a plane parallel to the central axis of the housing, the free upper edge of the housing (6) follows a substantially sinusoidal line.

The upper edge of the housing or volute is advantageously outwardly flanged, whereby the valleys are formed by cuts extending from the free edge.

In the apparatus according to the invention, it is possible to obtain a stable operation with a continuously full liquid flow with a very short screw centrifugal type impeller or with a propeller type impeller fixed to a very short shaft, with their upper end as close as possible to the upper edge of the volute or housing and at any position of the upper edge of the volute or housing between above and below the liquid level so the spray intention and mixing capacity can be chosen in function of the application and basin geometry.

In the apparatus of the invention, the upper edge of the housing or volute, possibly outwardly flanged or flared, is corrugated.

The shape can be a sine wave with a number of waves but other shapes like saw blade or rectangular wave or any other shapes are possible. The optimal shape, number of waves, height between the upper and lower part of the wave can be chosen and selected as required. Possibly the shape of the corrugation of the upper edge can be modified or adapted by displacement of two elements. Preferably, the number of waves will be the same as the number of support legs for the fixed design, or V-shaped ones for attachment of the floats for the floating design. The valleys will then preferably be adapted for directing major part of the liquid flow/flows between the legs or floats.

The position compared to the liquid surface can also be chosen in function of the application and basin geometry.

When used as an aerator, a minimum of the lower part or valleys of the wave or corrugated edge is advantageously immerged in the liquid so that the screw part in case of a screw centrifugal impeller or the complete propeller type impeller always faces a minimum liquid layer to be able to pump up a full flow at its start and during operation.

By increasing this immersion of the volute or housing, the apparatus will change its operation from maximum spray to maximum mixing and anything in between.

When the corrugated upper edge of the volute or housing is completely submerged, full mixing will be reached with little or no aeration.

In this case, the direction of rotation of the screw centrifugal type impeller can be chosen or controlled, in the same direction of an aerator or in the opposite direction.

The position of the upper corrugated edge is advantageously located adjacent to the liquid body surface, and can be controlled by a system so as to control the position of the bottom of the valleys with respect to the liquid body surface, so as to control the ratio aeration/mixing.

The axis of the volute or housing is preferably vertical, but in some case, said axis can be inclined with respect to the vertical.

For example, the lower immersion of the corrugated upper edge of the volute or housing and the number and shape of the waves are especially important for operation in a basin with a small surface. For this basin geometry, it can reduce the spray intensity to the basin walls and the pumping capacity can be increased by increasing the impeller diameter and/or pitch.

Another example is that the number and shape of the waves and the height between the upper and lower part of the wave can be chosen to adapt to special basin shape and dimensions, such as small and long basins and oxidation ditches. The spray needs to be reduced to the small side of the basin and more directed to the long side. In an oxidation ditch the spray needs to be reduced to the small side and more directed in the direction of the flow and reduced in the opposite direction of the flow in the ditch. In those basins with a floating apparatus, 2 floats will be preferred and the spray must be reduced towards the floats.

According to embodiments of the invention, the apparatus of the invention has one or more of the following details:
the apparatus further comprises at least one deflecting means selected from the group consisting of a static deflecting plate (5) attached to the supporting element (1), a deflecting disc (8) associated to the impeller, a deflecting disc associated to the rotatable shaft (3), and a combination thereof, while the impeller (4) is a screw centrifugal impeller having an upper portion (4A) extending at least partly outside the upper portion (6A) of the at least partly conical housing (6) above the upper free edge, the said screw centrifugal impeller expelling at least a portion of the pumped liquid towards the deflecting means for deflecting said portion of the pumped fluid. Advantageously, the deflecting means is located at a level above the corrugated free upper edge of the at least partly conical housing (6)
the at least partly conical housing (6) comprises: (a) an upper cylindrical part (6A) presenting the upper free edge of the housing (6), whereby said upper cylindrical part (6A) extends between a top upper plane perpendicular to the central axis of the housing, and a lower plane perpendicular to the central axis of the housing (6) and distant from the said top upper plane, and (b) a lower conical part (6B) attached to the upper cylindrical part (6A), whereby said top upper plane and said lower plane are distant from each other by a distance of at least 10 cm, advantageously at least 15 cm. Said distance is for example comprised between 10 cm and 50 cm, advantageously between 15 and 35 cm.
in case of a screw centrifugal type impeller, the upper cylindrical part of the housing (6) is defined by an inner diameter, in which the impeller has one or two or three blades defining one or two or three helixes with free end edges, whereby the upper portion of the impeller is located partly within the upper cylindrical part of the housing (6) and partly above the said upper cylindrical part of the housing, and whereby the free end edge(s) of the blade(s) of said upper portion of the impeller (4) extend(s) along a substantially cylindrical surface with a diameter corresponding to 0.9 to 0.995 times (such as 0.95 to 0.995 times) the inner diameter of the said upper cylindrical part of the housing. The diameter of the cylindrical part of the housing is for example comprised between 20 cm and 1 m, and will be adapted for example in function of the size of the pool to be aerated. The impeller has therefore blades extending within a cylinder shape having a diameter comprised for example between about 20 cm and about 100 cm.
the at least partly conical housing (6) comprises:
   (a) an upper cylindrical part (6A) presenting the corrugated free upper edge of the at least partly conical housing (6), whereby said upper cylindrical part (6A) extends between a top upper plane perpendicular to the central axis of the at least partly conical housing (6), and a lower plane perpendicular to the central axis of the at least partly conical housing (6) and distant from the said top upper plane, and
   (b) a lower conical part (6B) attached to the upper cylindrical part (6A), whereby said top upper plane and said lower plane are distant from each other by a distance of at least 10 cm. The apparatus is further characterised in that:,
   the upper cylindrical part (6A) of the at least partly conical housing (6) has an inner diameter,
   the impeller (4) has an upper portion (4A) with at least one blade defining at least one helix with a free end edge,
   whereby the upper portion (4A) of the impeller (4) has (i) a first part located partly within the upper cylindrical part (6A) of the at least partly conical housing (6), and (ii) a second part located above and outside the said upper cylindrical part (6A) of the at least partly conical housing (6), and
   whereby the free end edge of the helix defined by the blade of the first part of said upper portion (4A) of the impeller (4) extends along a substantially cylindrical surface with a diameter corresponding to 0.9 to 0.995 times the inner diameter of the said upper cylindrical part (6A) of the at least partly conical housing (6).

Advantageously, the upper portion (4A) of the impeller is selected from the group consisting of an upper portion comprising two blades defining two distinct helixes around the central axis, and an upper portion comprising three blades defining three distinct helixes around the central axis,
whereby each helix has a free end edge, and whereby each helix has (i) a first part located partly within the upper cylindrical part (6A) of the at least partly conical housing (6), and (ii) a second part located above and outside the said upper cylindrical part (6A) of the at least partly conical housing (6), and
whereby the free end edge of the first part of each helix extends along a substantially cylindrical surface with a diameter corresponding to 0.9 to 0.995 times the inner diameter of the said upper cylindrical part (6A) of the at least partly conical housing (6).

Preferably, the impeller (4) has a lower portion (4B) extending within the lower conical part (6B) of the at least partly conical housing (6).
the lower portion of the impeller extends within the lower conical part of the housing or volute (6).

This results in an extra reduction of the impeller length on one hand and reduces the risk of blockage with fibers or any other debris on the other hand. This shortened impeller length improves the centering in the volute or housing and allows for a smaller clearance between the volute or housing and the impeller.
the lower portion of the impeller has one or two or three blades defining one or two or three helixes with free end edges, whereby the free end edge(s) of the blade(s) of said lower portion of the impeller (4) extend(s) within a cylindrical volume having as axis the central axis of the housing and as diameter a diameter corresponding to 0.9 to 0.995 times (such as 0.95 to 0.995 times) the inner diameter of the said upper cylindrical part of the housing.
the impeller has one or two or three blades defining one or two or three helixes with free end edges, whereby the free end edge(s) of the blade(s) of at least the said upper portion of the impeller (4) has/have along the free end edge(s) of the upper portion of the impeller a reduced thickness, whereby said free end edge(s) has/have preferably a curved shape cross section.

This reduces friction losses in the clearance between the blades and the inner surface of the volute or housing.
the impeller (4) is selected from the group consisting of an impeller with one blade defining a helix around the central axis, an impeller with two blades defining two distinct helixes around the central axis, and an impeller with three blades defining three distinct helixes around the central axis, in which each helix has an end edge portion ending with a free end edge. The impeller (4) has furthermore an upper portion (4A) extending at least partly within the upper portion (6A) of the at least partly conical housing and at least partly outside the upper portion (6A) of the at least partly conical housing (6). The end edge portion of each helix extending in the upper portion (4A) of the impeller (4) is shaped to present a reduced thickness towards its free end edge.

Advantageously, the end edge portion of each helix extending in the upper portion (4A) of the impeller has a substantially curved cross-section.
The improved apparatus further comprises at least one deflecting means selected from the group consisting of a static deflecting plate (5) attached to the supporting element (1), a deflecting disc (8) associated to the impeller, a deflecting disc associated to the rotatable shaft (3), and a combination thereof, said deflecting means having a circular shape centred with respect to the central axis of the at least partly conical housing (6) and with an outer edge defined by a diameter,
   in which the upper opening of the at least partly conical housing (6) has a open circular section defined in a plane perpendicular to the central axis of the at least partly conical housing (6), said open circular section being centred with respect to the central axis and being defined by a diameter;
   in which the impeller (4) is a screw centrifugal impeller having an upper portion (4A) extending at least partly outside the upper portion (6A) of the at least partly conical housing (6) above the upper free edge, the said screw centrifugal impeller expelling at least a portion of the pumped liquid towards the deflecting means for deflecting said portion of the pumped fluid, and
   in which the diameter defining the outer edge of said deflecting means is at least by 10% greater than the diameter of the said open circular section of the upper opening of the at least partly conical housing (6).
The improved apparatus further comprises at least one deflecting means selected from the group consisting of a static deflecting plate (5) attached to the supporting element (1), a deflecting disc (8) associated to the impeller, a deflecting disc associated to the rotatable shaft (3), and a combination thereof,
   in which the impeller (4) is a screw centrifugal impeller having an upper portion (4A) extending at least partly outside the upper portion (6A) of the at least partly conical housing (6) above the upper free edge, the said screw centrifugal impeller expelling at least a portion of the pumped liquid towards the deflecting means for deflecting said portion of the pumped fluid, and
   in which said deflecting means has a lower face directed towards the upper portion (4A) of the screw centrifugal impeller, and an upper face opposite to said lower face, said upper face being chamfered.
The improved apparatus is an apparatus, in which the impeller (4) has at least one blade defining at least one screw path, whereby a top portion of the impeller comprises an upper portion of the at least one blade, said upper portion ending by an upper end, whereby the top portion is a part of the impeller selected from the group consisting of a disc and a part thereof covering the upper end of the at least one blade.
the impeller has at least one blade with an inner end edge attached to a central shaft and with an outer free end edge, whereby said at least one blade is defining a screw-like element around the central shaft, whereby the central shaft has a shaft central axis, whereby the said at least one blade has a slight upwards bending towards the outer free end edge, whereby the at least one blade defines a first pitch distance along the central shaft and a second pitch distance along the outer free edge, said first pitch distance and said second pitch distance being measured parallel to the shaft central axis, whereby the second pitch distance is greater than the first pitch distance.
The improved apparatus comprises at least a top outwardly flared system selected from the group consisting of a top outwardly flared portion of the housing (6), a top outwardly flared portion of the impeller (4), and a combination thereof.
The improved apparatus is provided with legs selected from the group consisting of supporting legs and supporting legs associated to a floating element, and which is further provided with at least one deflector selected from the group consisting of deflectors mounted on the supporting legs and deflectors mounted on the floating element.
the impeller has a lower portion extending within the conical portion of the housing on a height of less than 30 cm, such as less than 20 cm, preferably less than 10 cm, said lower portion having one or more blades having free edges extending along a substantially conical surface.
the housing or volute (6) and/or the impeller has/have a top outwardly flared portion.
the rotating deflecting disc fixed to the impeller or to the shaft has a diameter greater than, advantageously 10 to 40% greater than the diameter of the circular open cross section of the housing adjacent to the upper opening, whereby said deflecting disc (5) has a lower face directed towards the screw centrifugal type impeller, and an upper face opposite to said lower face. The upper face of the top face of the screw centrifugal type impeller is advantageously chamfered. This prevents freezing risk during standstill between the topside of the screw centrifugal type impeller and the lower face of the deflector plate.
the at least conical housing comprises a conical portion provided with inner blades forming two or more than two distinct inner channels, such as three or more than three distinct inner channels within a part of the housing, said inner channels having a height of at least 8 cm, advantageously from 15 to 100 cm, such as 20 cm, 30 cm, 50 cm and 75 cm.
the at least partly conical housing is provided with means for directing the liquid flow with the housing, advantageously at least at the aspiration side of the impeller, said means being advantageously a means preventing vortexing within the housing below the aspiration side/end of the impeller. Said means can be shaped with one or more plates and/or can form a cross. The plates are advantageously vertical, but can be shaped to direct or guide the liquid flow in the direction of the rotation of the impeller or in the opposite direction. The plates can be designed for impacting operation of the impeller (such as its flow rate and/or its maximal flow speed, especially maximal radial flow speed) and its power consumption. Possibly the means for guiding the liquid flow inside the housing or the inner plates can have a portion extending below the intake opening of the conical housing, so as to influence/control the flow of liquid, rotation of liquid in the liquid body, for example in function of the application and/or basin geometry.
Especially in case the impeller is of the screw centrifugal impeller type, the impeller has a top portion extending at least partly outside the upper portion of the housing (6), whereby said top portion is a centrifugal impeller part, advantageously associated to an element closing the upper ends of the blades.

With such top portion or “centrifugal part”, the blades can be fully closed or end with a gap against its conical central body. When the impeller is far submerged to work in a small surface basin it could be an advantage to fully close the blades against the conical central body in order to have more centrifugal force against the static head of the liquid in the basin or liquid body.
the impeller has one or more blades attached to a central shaft, whereby said blades have a slight upwards bending towards the free outer end edge, whereby the pitch of each blade is greater at its free outer end edge than along the central shaft.
the apparatus is provided with supporting legs to which the supporting element (1) is attached, advantageously in an adjustable manner
the legs are associated to one or more floating elements, whereby advantageously each floating element is attached to one or more legs by a connecting means enabling to adjust at least partly the position of the floating element with respect to said one or more legs.
the legs and/or the floating element(s) is/are provided with deflectors 88 with or without guiding element(s) 88b is, and/or guiding means, such as protuberance or ribs or fins (130). The deflectors are advantageously removably mounted on a leg, for protecting said leg from possible impact of material flowing with liquid expelled from the housing or volute 6. The guiding element 71 ter mounted on the deflector 88 acts also as means for indicating the level position of the deflecting plate 5.
the apparatus is provided with a cover advantageously with a central opening enabling access to the power drive (2). The cover (possibly mobile) can be fixed, advantageously in a removable way, to the apparatus or aerator or to a bridge or supporting element. For the apparatus provided with floating means, the cover can be placed on or attached to the floating means. The cover can be associated to solar panels or be adapted for being associated to solar panel. The cover can also be made from solar material itself, provided it can form a self-supporting structure. The cover can be flat, curved, conical, other shapes are possible. It can be manufactured from plastic, reinforced plastic or in any other light weight material. The cover can be associated to one or more peripheral flaps (such as flexible flaps), attached to the outer edge of the edge of the cover, said optional flaps enabling to reducing possible splashing and/or to reduce some noises or sounds. The central part of the cover located above the motor is advantageously open, said opening being then possibly partly or completely closed by mobile or removable closing means. The cover can also be fixed to the motor/deflector plate/impeller assembly.
the housing or volute comprises at least a main at least partly conical portion and an upper cylindrical portion mounted mobile with respect to the main portion between a first position defining first radial expelling zones for expelling each first volume of expelled liquid, and second radial expelling zones for expelling each second volume of expelled liquid, said second volume of expelled liquid being at least 25% larger than said first volume of expelled liquid through a first radial expelling zones, and a second position defining radial expelling zones different form the first position.
the impeller is a screw impeller with a central axis and with at least one blade defining a screw path without central hub.
The improved apparatus comprises at least two distinct floating means, said float means being each attached to the supporting element (1) by attaching means selected from the group consisting of attaching means attaching in a mobile way the supporting element (1) to the floating means, and attaching means attaching in a removable way the supporting element (1) to the floating means. Advantageously, the floating means have each lateral substantially vertical faces provided with a series of deflecting guiding protuberances.
The improved apparatus comprises supporting vertical legs attached to the supporting element (1), whereby said supporting vertical legs have each a vertical leading edge directed towards the at least partly conical housing (6), and whereby the said supporting vertical legs are each associated to substantially horizontal deflecting plate extending along the vertical leading edge.
the impeller is a screw centrifugal impeller (200) comprising at least two blades (201,202) forming a screw (203) with a central axis (204) and extending on an axial height between a top end (205) and a bottom end (206), said blades (201,202) having each an upper portion (201U,202U) adjacent to the top end and a lower portion (201L,202L) adjacent to the bottom end, whereby the upper portion (201U,202U) of each blades are attached to a deflector plate or disc (207), possibly with interposition of a central intermediate element (208), while the lower portions (201L,202L) of the blades (201,202) are connected the one to the other along the central axis (204) of the screw. Advantageously, the upper portions (201U,202U) of the blades are connected to the deflector plate or disc (207) with interposition of a central intermediate element (208), said intermediate element (208) having advantageously a cylindrical or conical or frustoconical shape, preferably a conical or frustoconical shape.
any combinations of one or more of these details.

The invention further relates also to an improved apparatus for at least mixing a liquid within a liquid body, advantageously of the type as disclosed here above, said apparatus comprising:
A supporting element (1);
A top-mounted power drive (2) mounted on said supporting element (1), said power drive having a rotatable shaft (3) extending downwardly toward the surface of said liquid body;
An impeller (4) mounted on said shaft (3) for rotation therewith;
a static deflecting plate (5) attached to the supporting element (1), and/or a deflecting disc, associated to the impeller (4) or to the shaft (3);
An at least partly conical housing or volute (6) with an upper portion (6A) ending with an upper free edge, and with a lower portion (6B) ending with a lower free edge, said housing being attached to the supporting element (1) or to a part attached to the said supporting element (1), said at least partly conical housing (6) defining an open channel (6C) between an upper opening and a lower opening, said housing or volute having substantially a central axis and a substantially circular cross section perpendicular to said central axis adjacent to the lower opening which is greater than a circular cross section adjacent to the upper opening;

Whereby the impeller (4) has at least a lower portion (4B) extending at least partly within the housing (6) and, advantageously when the impeller is of the screw centrifugal impeller type, an upper portion (4A) extending at least partly outside the housing (6), said impeller (4) being adapted so that the rotation thereof is able to generate a pumping of liquid within the housing (6) through its lower opening, and to expel said pumped liquid through the upper opening of the housing (6) or volute, before being at least partly deflected by contacting the deflecting plate (5) and/or the deflecting disc,

the said apparatus having one or more of the following characteristics:
the at least partly conical housing (6) comprises: (a) an upper cylindrical part (6A) presenting the upper free edge of the housing (6), whereby said upper cylindrical part (6A) extends between a top upper plane perpendicular to the central axis of the housing, and a lower plane perpendicular to the central axis of the housing (6) and distant from the said top upper plane, and (b) a lower conical part (6B) attached to the upper cylindrical part (6A), whereby said top upper plane and said lower plane are distant from each other by a distance of at least 10 cm, advantageously at least 15 cm. Said distance is for example comprised between 10 cm and 50 cm, advantageously between 15 and 35 cm.
the upper cylindrical part of the housing (6) is defined by a inner diameter, in which, especially in case of a screw centrifugal impeller type, the impeller has one or two or three blades defining one or two or three helixes with free end edges, whereby the upper portion of the impeller is located partly within the upper cylindrical part of the housing (6) and partly above the said upper cylindrical part of the housing, and whereby the free end edge(s) of the blade(s) of said upper portion of the impeller (4) extend(s) along a substantially cylindrical surface with a diameter corresponding to 0.9 to 0.995 (such as 0.95 to 0.995) times the inner diameter of the said upper cylindrical part of the housing or volute.
the lower portion of the impeller extends within the lower conical part of the housing or volute (6).

This results in an extra reduction of the impeller length on one hand and reduces the risk of blockage with fibers or any other debris on the other hand. This shortened impeller length improves the centering in the volute or housing and allows for a smaller clearance between the volute and the impeller.
the impeller has a lower portion extending within the conical portion of the housing on a height of less than 30 cm, such as less than 30 cm, such as less than 20 cm, preferably less than 10 cm, said lower portion having one or more blades having free edges extending along a substantially conical surface.
A portion, advantageously the lower portion of the impeller or a portion adjacent to the lower free end of the impeller, has one or two or three blades defining one or two or three helixes with free end edges, whereby the free end edge(s) of the blade(s) of said lower portion of the impeller (4) extend(s) within a cylindrical volume having as axis the central axis of the housing or volute and as diameter a diameter corresponding to 0.9 to 0.995 (such as from 0.95 to 0.995) times the inner diameter of the said upper cylindrical part of the housing or volute.
the impeller has one or two or three blades defining one or two or three helixes with free end edges, whereby the free end edge(s) of the blade(s) of at least the said upper portion of the impeller (4) has/have along the free end edge(s) of the upper portion of the impeller a reduced thickness, whereby said free end edge(s) has/have preferably a curved shape cross section.
   This reduces friction losses in the clearance between the blades and the inner surface of the volute or housing.
the housing or volute (6) and/or the impeller has/have a top outwardly flanged or flared portion.
the rotating deflecting disc (8) has a diameter greater than, advantageously 10 to 40% greater than the diameter of the circular open cross section of the housing adjacent to the upper opening, whereby said deflecting disc (5) has a lower face directed towards the impeller, and an upper face opposite to said lower face, said upper face being advantageously chamfered. This prevents freezing risk during standstill between the topside of the impeller and the deflector plate.
the at least conical housing comprises a conical portion provided with inner blades forming two or more than two (such as three, fourth or even more) distinct inner channels within a part of the housing, said channels having a height of at least 8 cm, advantageously from 15 to 100 cm.
the impeller has a top portion extending at least partly outside the upper portion of the housing (6), whereby said top portion is a centrifugal impeller part, advantageously associated to an element closing the upper ends of the blades. With such top portion or “centrifugal part”, the blades can be fully closed or end with a gap against its conical central body. When the impeller is far submerged to work in a small surface basin it could be an advantage to fully close the blades against the conical central body in order to have more centrifugal force against the static head of the liquid in the basin or liquid body.
the impeller has one or more blades attached to a central shaft, whereby said blades have a slight upwards bending towards the free outer end edge, whereby the pitch of each blade is greater at its free outer end edge than along the central shaft.
the apparatus is provided with supporting legs to which the supporting element (1) is attached, advantageously in an adjustable manner
the legs are associated to one or more floating elements, whereby advantageously each floating element is attached to one or more legs by a connecting means enabling to adjust at least partly the position of the floating element with respect to said one or more legs.
the legs and/or the floating element(s) is/are provided with deflectors 88 with or without guiding element(s) 88b is, and/or guiding means, such as protuberance or ribs or fins (130). The deflectors are advantageously removably mounted on a leg, for protecting said leg from possible impact of material flowing with liquid expelled from the housing or volute 6. The guiding element 88b is mounted on the deflector 88 acts also as means for indicating the level position of the deflecting plate 5.
the apparatus is provided with a means for controlling the position or the relative position of the upper edge of the volute or housing with respect to the liquid body surface. For example, the means is adapted for varying the relative position of the upper edge adjacent to the liquid body surface so as to control the ratio aeration/mixing.
the apparatus is provided with a cover advantageously with a central opening enabling access to the power drive (2). The cover (possibly mobile) can be fixed, advantageously in a removable way, to the apparatus or aerator or to a bridge or supporting element. For the apparatus provided with floating means, the cover can be placed or attached to the floating means. The cover can be associated to solar panels or be adapted for being associated to solar panel. The cover can also be made from solar material itself, provided it can form a self-supporting structure. The cover can be flat, curved, conical, other shapes are possible. It can be manufactured from plastic, reinforced plastic or in any other light weight material. The cover can be associated to one or more peripheral flaps (such as flexible flaps), attached to the outer edge of the edge of the cover, said optional flaps enabling to reduce possible splashing and/or to reduce some noises or sounds. The central part of the cover located above the motor is advantageously open, said opening being then possibly partly or completely closed by mobile or removable closing means. The cover can also be fixed to the motor/deflector plate/impeller assembly.
the housing or volute comprises at least a main at least conical portion and an upper cylindrical portion mounted mobile with respect to the main portion between a first position defining first radial expelling zones for expelling each first volume of expelled liquid, and second radial expelling zones for expelling each second volume of expelled liquid, said second volume of expelled liquid being at least 25% larger than said first volume of expelled liquid through a first radial expelling zones, and a second position defining radial expelling zones different form the first position.
means for positioning the intake side of the impeller into the intake cone (of the housing or volute).
   This results in an extra reduction of the impeller length on one hand and reduces the risk of blockage with fibers or any other debris on the other hand. This shortened impeller length improves the centering in the volute or housing and allows for a smaller clearance between the volute or housing and the impeller.
specific means for the motor support structure.
   This can be a triangle or a square depending on the application and basin geometry.
   This fits onto the support structure of the apparatus, which can be a triangle, hexagon or square.
means for positioning the motor higher above the liquid level.
   This way the motor is better protected against damage caused by foam or other material contained in the liquid. Furthermore, thanks to the important distance between the motor support structure and the impeller with volute or housing, there is no spray or liquid flow that can return to the lower motor seal and bearing.
A deflector plate just above the impeller especially in case of a screw centrifugal type impeller.
   The impeller bends the pumped flow to an angle to return to the liquid surface. If necessary, such deflector can add an extra angle which will be determined by the diameter and shape of the deflector.
Impeller disk (8) chamfered downwardly at the edge on the top side, especially in case of a screw centrifugal type impeller.
   This prevents freezing during standstill between the topside of the impeller and the deflector plate above it.
Impeller blades bent upwardly.
   The blades of the impeller can be slightly bent upwardly to get an increased pitch from the center to the outer edge of the blade.
No central hub.
   In case of a screw centrifugal impeller the screw part can be manufactured without central hub to increase the pumped-up flow. To maintain the strength of the screw construction, the blades can be connected at the center line of the impeller. This is not possible with a propeller type impeller.
Support legs.
   The fixed mounted apparatus can be designed with vertical plates as there are no floats. The height can then be set by adding spacers at the supports on top of the bridge.
   The floating apparatus uses the V-shape for attachment of the floats.
Small deflectors on the front of support legs and the V-shaped float connections.
   This prevents the reflection/splashing of liquid when it hits the front of the edge.
The shape of the slots in the floats is designed for the fixing of these floats.
The strength of the structure is optimized by using a double Triangle fixation: Triangular motor support flange installed on a triangular float fixation (14).
The mooring points are attached to the Triangular base structure and not to the floats as this directly transfers the torque of the motor to the mooring cables without applying load on the plastic floats.
Cone without separate volute or housing.
   Instead of using an intake cone with a cylindrical or conical or flared out volute or housing on top of it, we can use one cone that runs all the way up with a corrugated upper edge.
Internal plate or cross.
   This plate or cross inside the intake cone guides the rotation at the aspiration side of the impeller and prevents vortexing.
   Typically it is vertical but it can also be shaped to direct the flow in the direction of the rotation of the impeller or in the opposite direction. These designs influence the characteristics of the operation of the impeller and its power consumption.
   This internal plate or cross can optionally be extended below the intake cone to influence the rotation of the liquid in the basin or adapt it to the flow of the liquid in the basin in function of the application and basin geometry.
Cover on the aerator.
   For some locations, applications and/or basin geometry's, aerosols must be reduced. Therefore, a cover is necessary. Such a cover can easily be fixed to the aerator or to the bridge. In the floating execution, this cover can easily be placed on the floats without being floating itself or having to use extra floats. This cover can also be manufactured from solar panels or be made as a structure to install solar panels thereon. The cover can also be made from solar material itself, provided it can form a self-supporting structure. This cover can be flat, conical or curved in shape. The preferred material is re-enforced plastic because of the light weight. Optional flaps can be fixed to the outer edge to reduce the sound and residual splashing if necessary. The central part of the cover above the motor can be partially closed. It can also be separated from the cover. It can also be fixed to the “motor/deflector plate/impeller” assembly.
Multiple floats.
   Using 2 or more floats at a certain distance from the volute or housing instead of one central float allows the upper edge of the volute or housing to be completely or partially submerged.
   The preference goes to using 3 or 4 floats for stability in circular or square basins. In small/long basins and oxidation ditches preference goes to 2 floats.
Transport cost reduction.
   Using multiple floats reduces the transport cost especially for large units as the floats can be disassembled from the structure. This is a major advantage over the apparatus with one central float especially when the floats are larger than 2300 mm which do not fit in a standard container for transportation.
Large freeboard floats.
   Using multiple floats with a much larger freeboard than a central float, the portion of the stabilization plate or cross extending below the edge of the intake cone can be very small or avoided because it is not necessary for stability as counterweight.
V-shaped float fixings.
   These are also used as connection between the motor support flange and the volute or housing. By doing this the flange support legs above the volute or housing close to the impeller are not required any more. This excludes the risk of obstructing the spray of the aerator by clogging with fibers or other debris.
Hydrodynamic floats.
   The shape of the floats is preferably hydrodynamic as to minimize obstruction of the spray and induced flow. The floats can have a symmetrical shape or any other shape that is optimal for the operation conditions.
Removable spacers in the V-shaped support.
   The floats are fixed height by placing them in a V-shaped support that keeps them in place with 2 bent edges on this V. If the height must be adjustable, to avoid that the floats can slide up and down in the V, removable spacers with different thickness' are used.
   The total weight of the unit can indeed fluctuate due to:
      Motor weight can fluctuate depending on manufacturer and execution.
      Extended intake cone in function of the basin depth
      Addition of a cover on the aerator floats to reduce the aerosols and noise level
      Addition of a mixer below the intake cone of the aerator, such as preferably for the AER-AS/MIX-SL mixer marketed by Aquasystems International and its patent U.S. Pat. No. 6,227,525B1.
   Depending on the total weight of the apparatus, changing the position of the floats will enable the correct submergence of the volute or housing.
   This is not possible with a central float. Indeed, for every total weight of such apparatus; a different float height and diameter for each individual case is necessary and cannot be changed later on.
   The adjustment of the float immersion can be done in fixed steps with removable spacers. If requested, a system of continuous adjustment can set the immersion to a different level without disassembling the unit.
Re-enforcement ribs on the floats.
   Such ribs are provided for strengthening and are typically horizontal but can be hydraulically shaped to follow the spray pattern and the induced flow.
any combinations of one or more of these details and characteristics.

The invention further relates to a structure adapted to be associated to a pool containing a liquid body to be at least mixed or to the liquid body to be at least mixed and aerated, said structure being associated, advantageously in a detachable or removable way, with an improved apparatus according to the invention, as disclosed in the above description.

Advantageously, the structure comprises floating means, advantageously at least two, preferably three distinct floats, said floats being attached to supporting elements of the structure in a mobile and/or removable way.

Preferably, the structure comprises supporting vertical legs with each a vertical leading edge directed towards the housing, the said leg being associated to substantially horizontal deflecting plate extending along the leading edge. Especially, the float has lateral substantially vertical faces provided with a series of deflecting guiding protuberances.

The invention also relates to a specific screw centrifugal impeller (200) comprising at least two blades (201,202) forming a screw (203) with a central axis (204) and extending on an axial height between a top end (205) and a bottom end (206), said blades (201,202) having each an upper portion (201U,202U) adjacent to the top end and a lower portion (201L,202L) adjacent to the bottom end, whereby the upper portion (201U,202U) of each blades are attached to a deflector plate or disc (207), possibly with interposition of a central intermediate element (208), while the lower portions (201L,202L) of the blades (201,202) are connected the one to the other along the central axis (204) of the screw.

According to an advantageous embodiment, the upper portions (201U,202U) of the blades are connected to the deflector plate or disc (207) with interposition of a central intermediate element (208), said intermediate element (208) having advantageously a cylindrical or conical or frustoconical shape, preferably a conical or frustoconical shape.

Preferably, the lower portions (201L,202L) of the blades (201,202) are connected the one to the other along the central axis (204) of the screw on a distance equal or greater than 50% of the axial height of the screw.

Most preferably, the upper portions (201U, 202U) of the blades (201,202) are distant from the deflector plate or disc (207) by a distance equal to or greater than 0.5 cm, such as greater than 1 cm, advantageously from 1 to 10 cm.

The invention has also for subject matter an improved apparatus for at least mixing a liquid within a liquid body, advantageously for mixing and aerating a liquid within a liquid body, said improved apparatus comprising the improvement that it comprises a specific screw centrifugal impeller (200) comprising at least two blades (201,202) forming a screw (203) with a central axis (204) and extending on an axial height between a top end (205) and a bottom end (206), said blades (201,202) having each an upper portion (201U,202U) adjacent to the top end and a lower portion (201L,202L) adjacent to the bottom end, whereby the upper portion (201U,202U) of each blades are attached to a deflector plate or disc (207), possibly with interposition of a central intermediate element (208), while the lower portions (201L,202L) of the blades (201,202) are connected the one to the other along the central axis (204) of the screw, or an embodiment of such a screw impeller having one or more of the above disclosed details. The apparatus can also have one or more details or characteristics disclosed above for an apparatus of the invention.

The invention still relates to the use of an apparatus of the invention as disclosed in the following description, for mixing and/or for mixing and aerating a waste liquid body contained within a pool, such as containing waste materials to be treated or oxygenated, such as for example only pool contaminated with blue algae.

The invention further relates to a method for aerating and mixing the liquid body by using an apparatus according to the invention.

Especially, the said process is a process for mixing and aerating a liquid within a liquid body, said process using an apparatus for pumping liquid into a vertical at least partly conical housing, so as to form an upwards flow of pumped fluid into the said vertical at least partly conical housing towards an upper opening, and so as to expel said pumped fluid through said upper opening, in which the apparatus comprises:
A supporting element (1);
A top-mounted power drive (2) mounted on said supporting element (1), said top-mounted power drive (2) having a rotatable shaft (3) extending downwardly toward the liquid surface of said liquid body;
An impeller (4) mounted on said rotatable shaft (3) for rotation therewith;
An at least partly conical housing (6), said housing comprising at least an upper portion (6A) ending with an upper free edge, and a lower portion (6B) ending with a lower free edge, whereby said at least partly conical housing (6) is attached to an element selected from the group consisting of the supporting element (1) and a part attached to the said supporting element (1), whereby said at least partly conical housing (6) defines an inner open channel (6C) between an upper opening and a lower opening, said inner open channel of the at least partly conical housing (6) having substantially a central axis, whereby defining at least a first substantially circular cross section perpendicular to said central axis adjacent to the upper opening and a second substantially circular cross section perpendicular to said central axis of symmetry adjacent to the lower opening, said second substantially circular cross section being greater than the said first substantially circular cross section;

Whereby the impeller (4) has at least a lower portion (4B) extending at least partly within the at least partly conical housing (6), and whereby said impeller (4) is adapted so that when driven into rotation by driving into rotation the said rotatable shaft (3), the impeller (4) generates (a) a pumping of liquid within the at least partly conical housing (6) through its lower opening, whereby generating pumped liquid to flow through said at least partly conical housing (6) from the lower opening towards the upper opening, and (b) to expel said pumped liquid through the upper opening of the at least partly conical housing (6), and

Whereby the upper free edge of the upper portion (6A) of the at least partly conical housing (6) is a corrugated free upper edge defining peaks and valleys, whereby two successive peaks are separated by a valley, and whereby the distance measured parallel to the central axis of the at least partly conical housing (6) between the top of a peak and the bottom of a valley is greater than or equal to 2 cm,
the said process being characterised in that pumped liquid is expelled from the apparatus in accordance to at least a series of first radial liquid expelling zones and a series of second radial liquid expelling zones, whereby a second radial liquid expelling zone is located between two successive first radial liquid expelling zones, while a first radial liquid expelling zone is located between two successive second radial liquid expelling zones,
whereby the first radial liquid expelling zones are each characterised by at least a first parameter selected from the group consisting of liquid expelling speed, liquid expelling rate per angular section unit, and combination thereof, while the second radial liquid expelling zones are each characterised by at least a first parameter selected from the group consisting of liquid expelling speed, liquid expelling rate per angular section unit, and
wherein the first parameter of the first radial liquid expelling zones differs by at least 10% (such as 20% or more, 25% or more, 50% or more) from the second parameter of the second radial liquid expelling zones.

### BRIEF DESCRIPTION OF THE DRAWINGS

FIG. 1 is a top view of a preferred embodiment of an apparatus of the invention;

FIG. 2 is a lateral view of the embodiment of FIG. 1;

FIG. 3 is a cross section view of a detail of a blade of the impeller extending within the upper cylindrical part 63 of the housing 6;

FIG. 4 is a partial view of a preferred blade of the impeller of the apparatus of the invention;

FIG. 5 is a perspective view of an embodiment of a floating element of an apparatus of the invention;

FIG. 6 are cross section views of possible floating elements;

FIG. 7 is perspective view of two possible volute or housing embodiments;

FIG. 8 is a bottom view of the volute or housing embodiments of FIG. 7;

FIG. 9 is a further view of a possible volute;

FIG. 10 is further views (perspective, lateral and top views) of an embodiment of volute or housing 6;

FIGS. 11A and B are views of the upper portion of two impellers for an apparatus of the invention;

FIG. 12 is a perspective view of a further possible embodiment of the volute or housing 6;

FIG. 13 is a plane-developed view of the top edge of the upper part of the housing or volute of FIG. 2;

FIG. 14 is a perspective view of the apparatus of FIGS. 1 and 2;

FIG. 15 is perspective enlarged view of the detail AA of FIG. 15;

FIG. 16 is a schematic view of an apparatus of the invention provided with a screw centrifugal type impeller,

FIG. 17 is a schematic view of an apparatus of the invention provided with a propeller type impeller;

FIGS. 18 to 21 are schematic view of working of aeration apparatuses not according to the invention, while FIG. 22 is a schematic view of a working of an apparatus according to the invention;

FIGS. 23 and 24 are views of an advantageous embodiment of a screw impeller suitable for an apparatus of the invention; and

FIGS. 25 and 26 are views of another advantageous embodiment of a screw impeller suitable for an apparatus of the invention.

### DESCRIPTION OF PREFERRED EMBODIMENTS

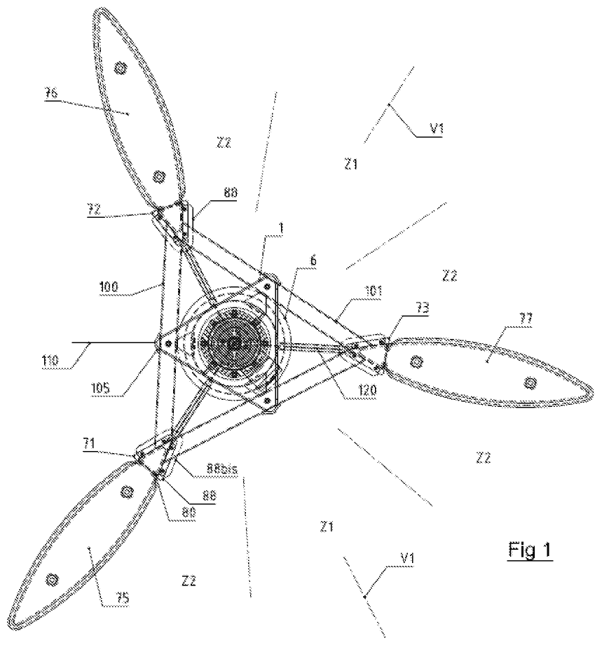

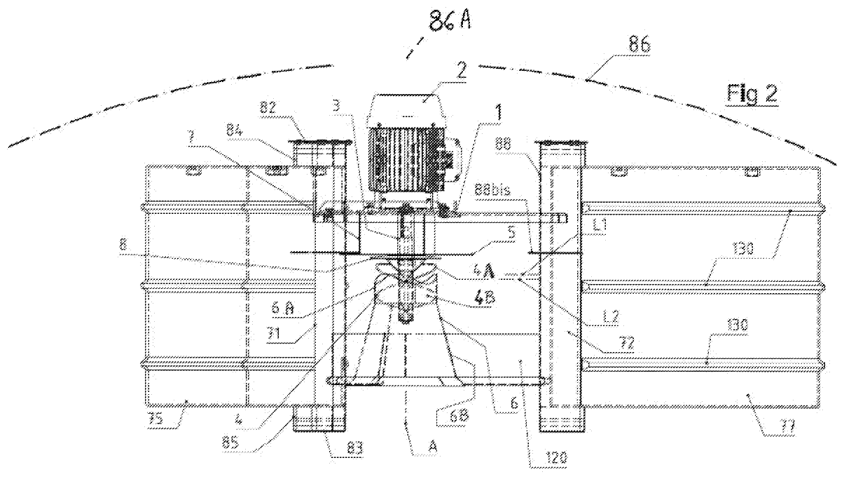

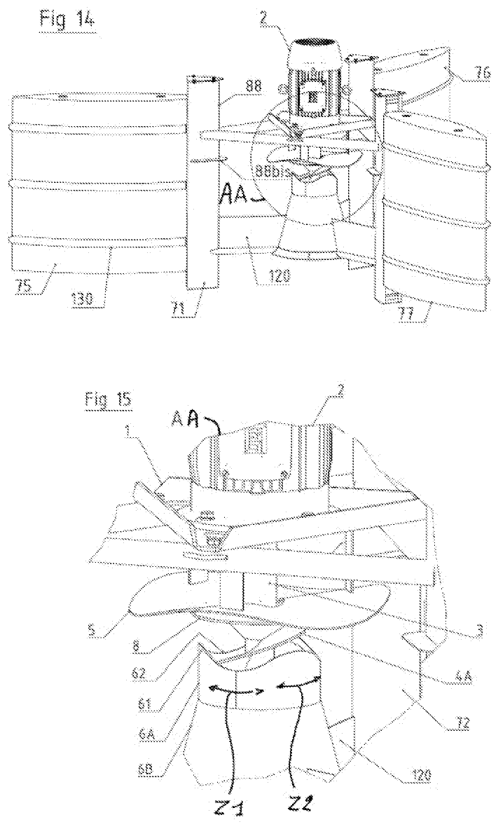

FIG. 1 is a top view of a preferred embodiment of the apparatus of the invention for at least mixing a liquid within a liquid body. FIG. 2 is a lateral side view of the apparatus of FIG. 1. FIGS. 14 and 15 are perspective views of the said apparatus, and of a detail thereof (AA).

The apparatus comprises:
A supporting element (1);
A top-mounted power drive (2) mounted on said supporting element (1), said power drive having a rotatable shaft (3) (around its axis A) extending downwardly toward the surface of said liquid body;
An impeller (4) mounted on said shaft (3) for rotation therewith, said impeller (4) having an upper portion (4A) adjacent to an upper end of the impeller and a lower portion (4B) adjacent to the lower end of the impeller;
Advantageously a deflecting plate (5) associated to the supporting element (1) via attachment means (7), said deflecting plate (5) having a central opening for the free passage of the shaft (3), as well as a deflecting disc (8) attached to the rotating shaft (3), said deflecting disc being located below the deflecting plate (5) which is located below the power drive (2);
An at least partly conical housing or volute (6) with an upper portion (6A) ending with an upper free edge, and with a lower portion (6B) ending with a lower free edge (possibly with an outwardly flared en, said housing (6) being attached to the supporting element (1) or to a part attached to the said supporting element (1), said at least partly conical housing (6) defining an open channel (6C) between an upper opening and a lower opening, said housing or volute (6) having substantially a central axis and a substantially circular cross section perpendicular to said central axis adjacent to the lower opening which is greater than a circular cross section adjacent to the upper opening;

Whereby the impeller (4) has at least a lower portion (4B) extending at least partly within the housing (6) and, advantageously when the impeller is of a screw centrifugal impeller type, an upper portion (4A) extending at least partly outside the housing (6), said impeller (4) being adapted so that the rotation thereof is able to generate a pumping of liquid within the housing (6) through its lower opening, and to expel said pumped liquid through the upper opening of the housing (6), before being at least partly deflected by contacting the deflecting plate (5).

The upper portion (6A) of the housing or volute (6) has a corrugated upper edge defining peaks and valleys, two successive peaks being separated by a valley, while the distance measured parallel to the axis of the housing or volute (6) between the top of a peak and the bottom of a valley is at least 2 cm or equal to 2 cm, advantageously from 5 to 50 cm, preferably from 10 to 30 cm. Said upper corrugated edge working with the deflecting plate (5) and/or the deflecting disc are adapted for achieving, at least when the peaks of said corrugated upper edge are partly above the liquid body surface and the valleys are partly below the liquid body surface, a quite flat liquid spray above the liquid body surface, with two or more than two distinct and separated quite stable spray points or zones.

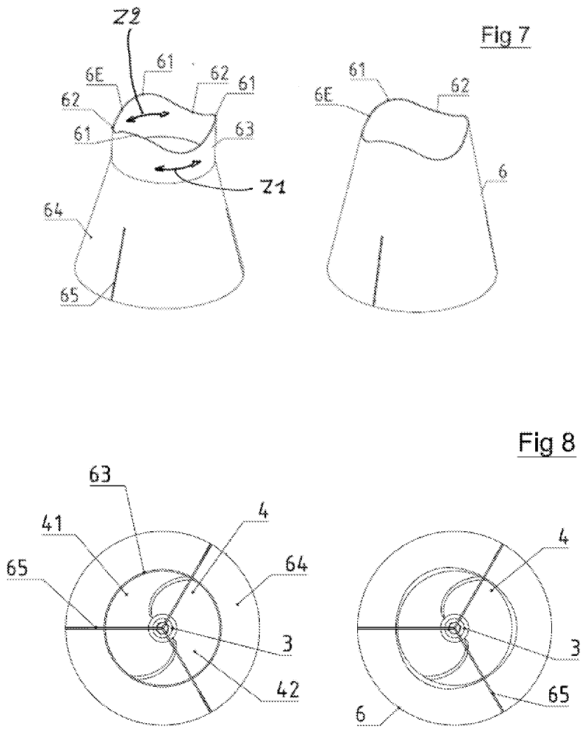

The upper portion (6A) of the housing (6) and/or the deflecting plate or deflecting disc (5,8) is adapted for defining first radial expelling zones (Z1) for expelling each first volume of expelled liquid (liquid flowing above the valley radial sector 62—see FIG. 7 as example), and second radial expelling zones (Z2) for expelling each second volume of expelled liquid (liquid flowing above the peak radial sector 61).

For example, the upper portion (6A) of the housing (6) and/or the deflecting plate (5) and/or the deflecting disc is/are adapted for defining at least one first substantially radial liquid expelling zone for a first volume of expelled liquid with a first maximal flow rate and/or with a first maximal flow speed, and at least one second substantially radial liquid expelling zone for a second volume of expelled liquid with a second maximal flow rate and/or a second maximal flow speed, whereby said first substantially radial liquid zone differs from the second substantially radial liquid zone for the liquid expelled from the housing and/or above the housing, by its maximal flow speed and/or its maximal flow rate per angular section unit. Advantageously, the maximal flow speed and/or the maximal flow rate per angular section unit of the first substantially radial liquid expelled zone is at least 10%, advantageously at least 20%, preferably at least 25% greater than respectively the maximal flow speed and/or the maximal flow rate per angular section unit of the second substantially radial liquid expelled zone.

Advantageously, said first substantially radial liquid zone differs from the second substantially radial liquid zone for the liquid expelled from the housing and/or above the housing, by its maximal flow speed and its maximal flow rate per angular section unit. Most preferably, the maximal flow speed and the maximal flow rate per angular section unit of the first substantially radial liquid expelled zone are at least 10%, advantageously at least 20%, preferably at least 25% greater than respectively the maximal flow speed and the maximal flow rate per angular section unit of the second substantially radial liquid expelled zone.

According to the shown preferred embodiment, the upper portion (6A) of the housing (6) and/or the deflecting plate (5) and/or the deflecting disc is/are adapted for defining at least two first substantially radial liquid expelling zones, each first zone for a first volume of expelled liquid with a first maximal flow rate and/or with a first maximal flow speed, and at least two second substantially radial liquid expelling zones, each second zone for a second volume of expelled liquid with a second maximal flow rate and/or a second maximal flow speed, whereby said first substantially radial liquid zones differ from the second substantially radial liquid zones for the liquid expelled from the housing and/or above the housing, by the maximal flow speed and/or the maximal flow rate per angular section unit.

Advantageously, the maximal flow speed and/or the maximal flow rate per angular section unit of each first substantially radial liquid expelled zone is at least 10%, advantageously at least 20%, preferably at least 25% greater than respectively the maximal flow speed and/or the maximal flow rate per angular section unit of each second substantially radial liquid expelled zone.

Advantageously, each of said at least two first substantially radial liquid zones differs from the said second substantially radial liquid zones for the liquid expelled from the housing and/or above the housing, by its maximal flow speed and its maximal flow rate per angular section unit. Most preferably, the maximal flow speed and the maximal flow rate per angular section unit of each of said first substantially radial liquid expelled zone are at least 10%, advantageously at least 20%, preferably at least 25% greater than respectively the maximal flow speed and the maximal flow rate per angular section unit of each of said at least two second substantially radial liquid expelled zones.

A second radial liquid expelled zone Z2 is advantageously located between two first radial liquid expelled zones Z1. The second radial liquid expelled zone can be a zone with substantially no liquid flow or with a reduced liquid flow contacting the legs. By ensuring preferred radial flow directions for the spray expelled from the volute or housing 6, it is possible to ensure a better control of partly opposite forces exerted on the apparatus by the spray.

Advantageously said result is achieved by adapting the shape of the free upper edge of the volute or housing 6. It is clear that other means can be used as alternatives of said special shape of the free upper edge. The upper portion of the housing or volute 6 can also be provided with openings for the passage of a portion of the flow of liquid pumped by the impeller 4.

A zone Z2 is preferably is preferably located between two zones Z1. The zone Z2 can extend on a radial section smaller or greater than the radial section of a zone Z1.

Preferably in the apparatus of the invention, the free upper edge of the housing or volute (6) extends between an upper plane L1 perpendicular to the central axis A of the housing (6) and a lower plane L2 perpendicular to the central axis distant from the said upper plane L1 by a distance of at least 5 cm, advantageously by a distance comprised between 5 and 25 cm. The level L1 is adapted with respect to the liquid level of the pool, so as to achieve the desired mixing or aeration.

The central axis A of the housing 6 is advantageously the axis of the shaft 3.

Preferably (see FIG. 7), the free upper edge 6E of the volute or housing 6 has a series of peaks 61 and a series of valleys 62 having each a bottom, whereby two successive peaks 61 are separated the one from the other by a valley 62 with a bottom, whereby each of the said peaks 61 extends advantageously within the said upper plane L1, and/or whereby each bottom of the said valleys extends advantageously within the lower plane L2. The said valleys 62 are means for generating zones Z2 when the impeller 4 is driven into rotation, while the peaks 61 are means for generating zones Z1 when the impeller 4 is driven into rotation.

Most preferably, the peaks 61 and valleys 62 are located within a partly cylindrical upper portion 63 of the housing, whereby when developing the said partly cylindrical upper portion 63 of the housing in a developing plane, the peaks and valleys are at least partly curved. As shown in FIG. 7, the volute or housing 6 can in some embodiments be only frustoconical.

According to a detail of a preferred embodiment, the free upper edge comprises from 2 to 10, preferably from 3 to 6 peaks or teeth, most preferably 3 or 4 or 5 peaks or teeth and 3 or 4 or 5 valleys 62.

Especially, when developed within a plane parallel to the central axis of the housing, the free upper edge of the housing (6) follows a substantially sinusoidal line. Curved shape between peaks and bottoms is advantageous for generating intermediate zones between Z2 and Z1, said intermediate zones being zones with adapted or intermediate expelled liquid volume/flow rate comprised between the peak expelled liquid volume/flow rate measured at the bottom of a valley and the lower expelled liquid volume/flow rate at the peak of the upper edge. By using curved upper edge between peaks and bottoms, the flow rate of expelled liquid above the free upper edge of the volute or housing varies substantially continuously between a top flow rate and a bottom flow rate between the bottoms of the valleys and the tops of the peaks of the upper edge.

In the apparatus according to the invention, it is possible to obtain a stable operation with a continuously full liquid flow with a very short impeller with its lower end as close as possible to the upper edge of the volute or housing and at any position of the upper edge of the volute or housing between above and below the liquid level so the spray intention and mixing capacity can be chosen in function of the application and basin geometry.

The upper edge of the volute or housing can be positioned with respect to the liquid level of liquid to be mixed and/or aerated, so that the peaks are positioned above the liquid level, while the bottom of the valleys are located below the liquid level.

In the apparatus of the invention of FIG. 1, the upper edge of the housing or volute 6 is corrugated.

The shape can be a sine wave with a number of waves but other shapes like saw blade or rectangular wave or any other shapes are possible. The optimal shape, number of waves, height between the upper and lower part of the wave can be chosen and selected as required. Possibly the shape of the corrugation of the upper edge can be modified or adapted by displacement of two elements. Preferably, the number of waves will be the same as the number of support legs for the fixed design, or V-shaped ones for attachment of the floats for the floating design. The valleys will then preferably be adapted for directing major part of the liquid flow flows between the legs or floats, so as to avoid or limit the flow rate of liquid or the liquid speed contacting the legs or floats.

The position compared to the liquid surface can also be chosen in function of the application and basin geometry.

For example, the maximum flow rate of liquid (radial section Z1—see FIG. 1) is located in a vertical plane between two successive floats or legs, advantageously the median vertical plate V1 between two successive floats or legs (75,76,77). Said maximum flow corresponds to the flow flowing through the valley 62. The liquid flow in the radial section Z2 corresponds to the flow passing over the peak 61, said liquid flow being partly directed towards a float or its deflector 88.

When used as an aerator, a minimum of the lower part of the wave shaped edge is advantageously immerged in the liquid so that the screw part in case of a screw centrifugal impeller or the complete propeller type impeller always faces a minimum liquid layer to be able to pump up a full flow at its start and during operation.

By increasing this immersion of the volute or housing (6), the apparatus will change its operation from maximum spray to maximum mixing and anything in between.

Possibly the upper edge of the volute or housing (6) has two parts, namely one part immersed for aeration purposes, while another part is located above the liquid level, for mixing purposes. By this way, we can adapt the ratio between aeration/mixing of the liquid as required, for example for limiting the foaming and/or for increasing the foam breaking.

When the corrugated upper edge of the volute or housing 6 is completely submerged, full mixing will be reached with little or no aeration or with a minimum level of aeration.

By adapting the position of the corrugated edge, it is thus possible to control the ratio between the aeration level and the mixing level within a minimum and a maximum, as well the foaming/foam breaking ratio, as some expelled flow portions can be considered as being generating some foaming, while some other portions of the expelled flow can be considered as foam breaking.

The axis of the volute or housing 6 is preferably vertical, but in some case, said central axis A can be inclined with respect to the vertical.

The valleys can have different shapes, for example can have a bottom extending in different horizontal planes. In this way, it is possible to have different flow of liquid expelled through the various valleys.

Furthermore, the direction of rotation of the impeller can be chosen or controlled, in the same direction of an aerator or in the opposite direction.

For example, the lower immersion of the corrugated upper edge of the volute or housing and the

number and shape of the waves are especially important for operation in a basin with a small surface. For this basin geometry, it can reduce the spray intensity to the basin walls and the pumping capacity can be increased by increasing the impeller diameter and/or pitch.

With the design of existing aerators this reduction of the spray intensity can only be done with spray deflecting plates, but this also reduces both aeration and induced flow.

Another example is that the number and shape of the waves and the height between the upper and lower part of the wave can be chosen to adapt to special basin shape and dimensions, such as small and long basins and oxidation ditches. The spray needs to be reduced to the small side of the basin and more directed to the long side. In an oxidation ditch the spray needs to be reduced to the small side and more directed in the direction of the flow and reduced in the opposite direction of the flow in the ditch. In those basins with a floating apparatus, 2 floats will be preferred, and the spray must be reduced towards the floats.

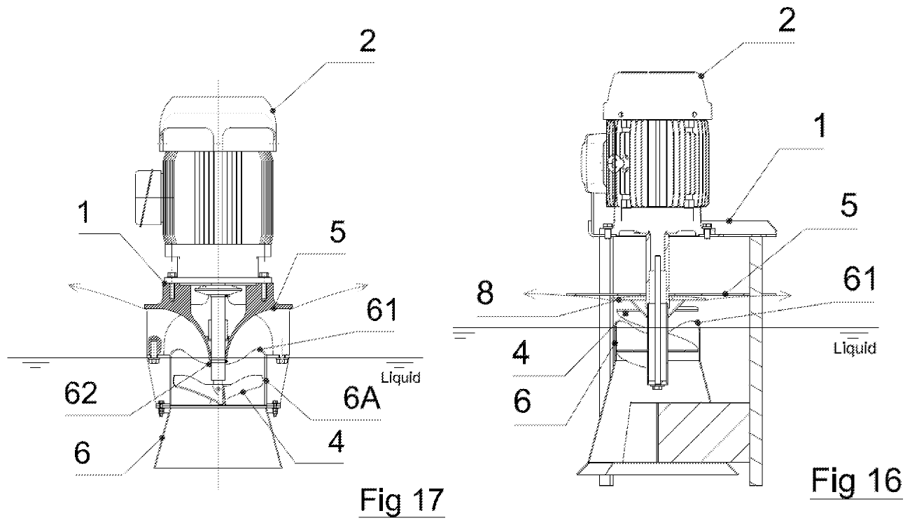

FIG. 16 is a schematic view of an apparatus of the invention associated with a screw centrifugal type impeller 4 extending partly within the housing 6, and partly above the housing 6, said housing having peaks extending above the liquid level and valleys located below the liquid level. The shaft is provided with a deflecting disc 8. The apparatus is also provided with a static deflecting plate 5. A portion of the liquid flow flowing through the cylindrical part 6A of the housing flows above the valleys, while another portion of said liquid flow is flowing above the peaks.

The water flow passing over the valleys has different characteristics (flow rate and speed) than the water flow passing over the peaks.

FIG. 17 is a schematic view similar of an apparatus like that of FIG. 16, but with propeller type impeller 4 extending within the cylindrical part 6A of the housing. Said housing 6 has an upper edge with peaks 61 and valleys 62. The supporting element is associated with a static conical deflecting means 5.

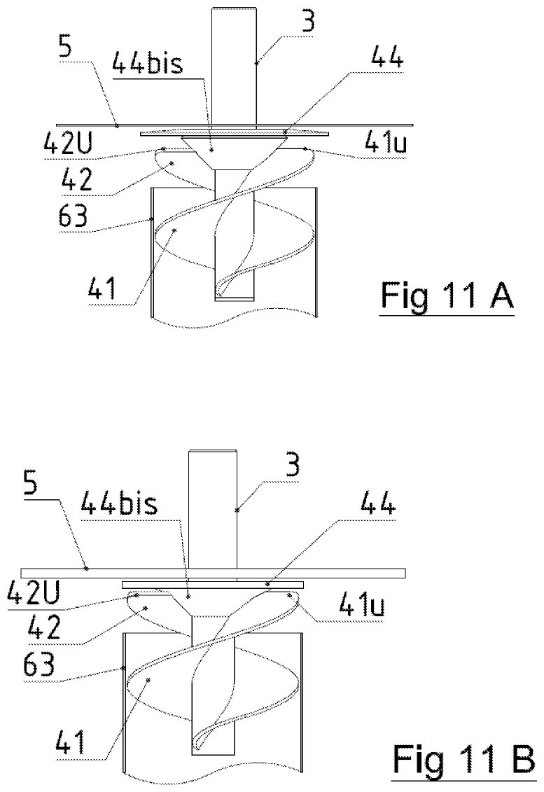

According to one or more preferred embodiments of the invention, the apparatus of the invention has one or more of the following details, or a combination thereof:
the at least partly conical housing or volute (6) comprises: (a) an upper cylindrical part (63) presenting the upper free edge of the housing (6) located below a free upper top plane perpendicular to the central axis A of the housing, and a bottom line extending within a lower plane perpendicular to the central axis of the housing (6), and (b) a lower conical part (64) attached to the bottom line the upper cylindrical part (63), whereby said free upper top plane and said lower plane of the said bottom line being distant from each other by a distance of at least 10 cm, advantageously at least 15 cm. The lower conical part 64 is directed towards the bottom of the pool containing the liquid to be mixed and/or aerated. The conical part 64 is preferably associated along its bottom opening with one or more inner flaps or fins 65 (see FIG. 8). The number of inner fins 65 can be adapted in function of the purpose or in function of the number of peaks or valleys.
the conical portion of the volute or housing 6 defines, perpendicular to the axis A, a bottom circular cross section with a bottom inner diameter and an upper circular cross section with an upper inner diameter (corresponding to the inner diameter of the substantially cylindrical part 63), the ratio between the bottom diameter and the upper diameter being advantageously comprised between 1.5 and 4, for example about 2 to about 3. The conical part has a height for example of 50 cm to 150 cm, for a bottom diameter of about 85 cm to about 200 cm. The surface of the cone is generated by the revolution of a line around a central axis, said line forming an angle comprised between 8 and 20°, preferably from 10 to 15°, with the central axis.
the upper cylindrical part 63 of the housing (6) is defined by a inner diameter, in which the impeller 4 has one or two or three blades 41,42 defining one or two or three helixes with free end edges 43, whereby the upper portion of the impeller 4 is located partly within the upper cylindrical part 63 of the housing (6) and partly above the said upper cylindrical part 63 of the housing, whereby the free end edge(s) 43 of the blade(s) of said upper portion of the impeller (4) extend(s) along a substantially cylindrical surface with a diameter corresponding to 0.9 to 0.995 times the inner diameter of the said upper cylindrical part of the housing. (see FIGS. 11A and 11B)

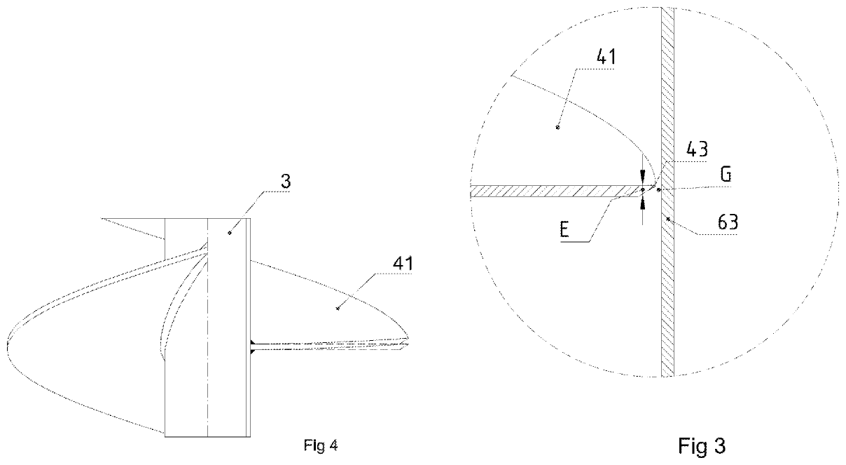

This results in an extra reduction of the impeller length on one hand and reduces the risk of blockage with fibers or any other debris on the other hand. This shortened impeller length improves the centering in the volute or housing and allows for a smaller clearance between the volute or housing and the impeller.
the lower portion of the impeller extends within the lower conical part of the housing (6).
the lower portion of the impeller has one or two or three blades defining one or two or three helixes with free end edges, whereby the free end edge(s) of the blade(s) of said lower portion of the impeller (4) extend(s) within a cylindrical volume having as axis the central axis of the housing and as diameter a diameter corresponding to 0.95 to 0.995 times the inner diameter of the said upper cylindrical part of the housing (see FIG. 3). The gap G between the free edge 43 of the blade 41 and the inner surface of the upper part 61 of the housing 6 is for example below 2 cm, advantageously from 0.5 cm to 1.5 cm. Said restricted gap G enables to achieve an excellent pumping function.
the impeller 4 has one or two or three blades 41,42 defining one or two or three helixes with free end edges 43, whereby the free end edge(s) of the blade(s) of at least the said upper portion of the impeller (4) has/have along the free end edge(s) 43 of the upper portion 4A of the impeller 4 a reduced thickness E, whereby said free end edge(s) adjacent to the inner surface of the upper cylindrical part 63 of the housing 6 has/have preferably a curved shape cross section.

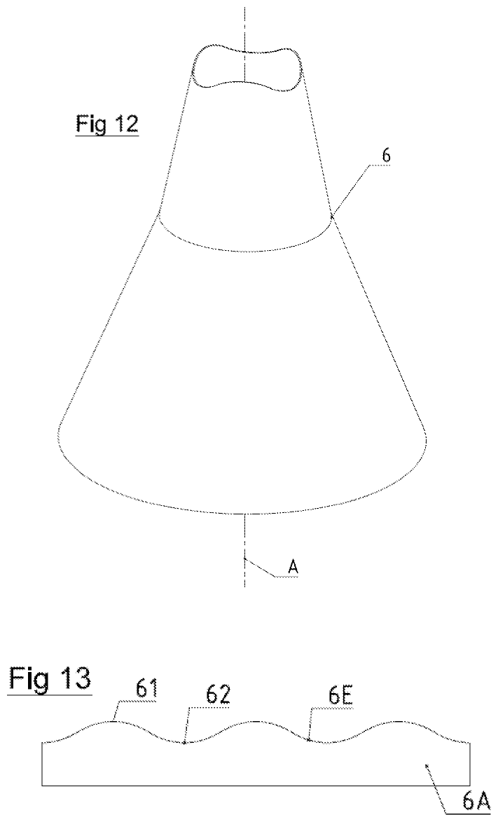

This reduces friction losses in the clearance G between the blades and the inner surface of the volute or housing 6 (see FIG. 3).
the impeller 4 has a lower portion 4B extending within the conical portion 64 of the housing 6 on a height of less than 30 cm, preferably less than 10 cm, said lower portion 4B having one or more blades 41,42 having free edges extending along a substantially conical surface. It has been observed that with such embodiment less turbulence is generated within the conical bottom part of the housing 6.
the housing or volute (6) and/or the impeller 4 has/have a top outwardly flared portion. FIG. 10 (lateral and upper views) shows a housing with a top outwardly flared portion 66 provided with cuts 67 for defining valleys, between uncut portions 68 defining the peaks.
FIG. 11 shows a detail of the upper part of the impeller 4 located above the housing 6. The blades 41 and 42 are at their top outwardly flared above the cylindrical portion 63 of the housing. The Top portions of the blades 41,42 are attached to frustoconical part 33 attached to the shaft 3. Said outwardly top portions of the blades 41,42 improve the pumping efficiency of the flow of liquid through the cylindrical part of the housing 6.
FIG. 12 is perspective view of another possible embodiment of a housing 6, which is the association of two conical parts, the upper conical parts having a more inclined generating line than the lower conical part.
The deflecting disc 8 has a diameter greater than, advantageously 10 to 40% greater than the diameter of the circular open cross section of the housing 6 adjacent to the upper opening, whereby said deflecting disc (8) has a lower face directed towards the impeller, and an upper face opposite to said lower face, said upper face directed to the deflecting blade (5) being advantageously chamfered. This prevents freezing risk during standstill between the topside of the impeller and the deflector plate.
The at least conical housing comprises a conical portion provided with inner blades 65 forming at least two (such as three) distinct inner channels within a part of the housing, said channels having a height of at least 8 cm, advantageously from 15 to 100 cm.
The impeller 4 has a top portion 63 extending at least partly outside the upper portion of the housing (6), whereby said top portion is a centrifugal impeller part, advantageously associated to an element 44 or 8 closing partly the upper ends of the blades.

With such top portion or “centrifugal part”, the blades can be fully closed or end with a gap against its conical central body. When the impeller is far submerged to work in a small surface basin it could be an advantage to fully close the blades against the conical central body in order to have more centrifugal force against the static head of the liquid in the basin.

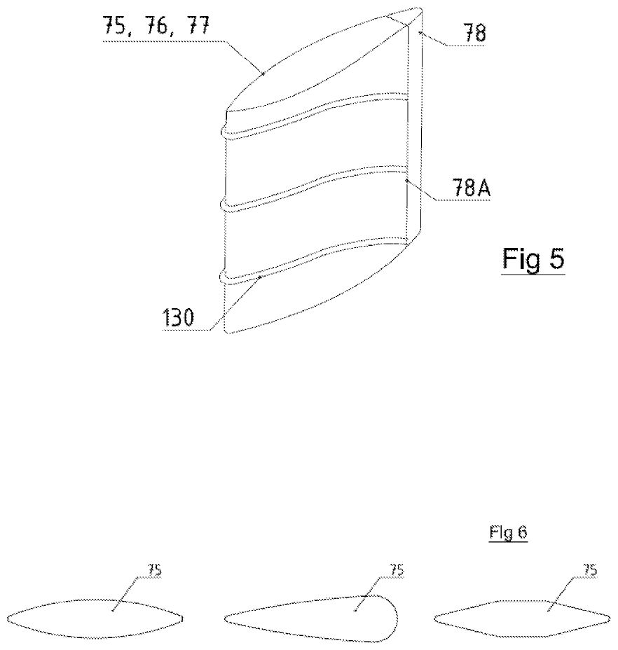

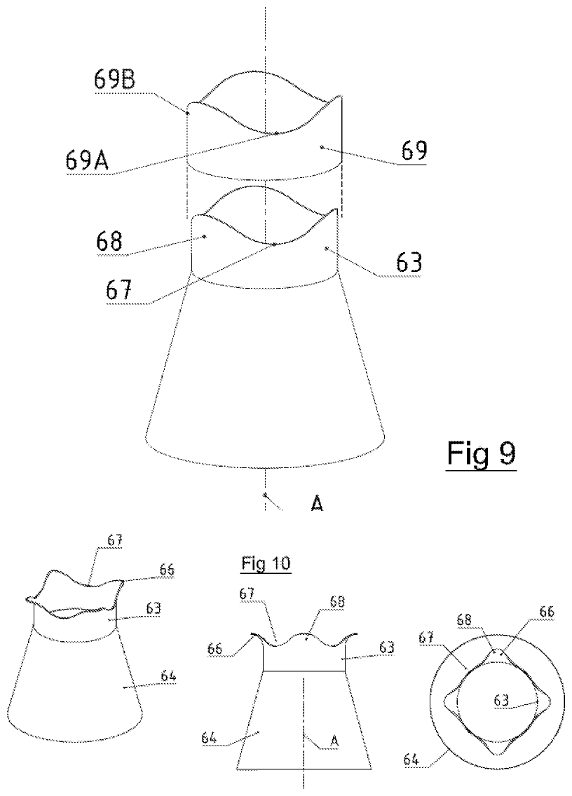

The element 44 (corresponding to element 8 in FIG. 2) is for example a disc 44, possibly chamfered as shown in FIG. 11A, said disc 44 being associated to a conical part 44b is along its face directed towards the blades 41,42. The upper free end 41U,42U of the blades are in the embodiments of FIGS. 11A and B distant from the disc 44.
The impeller 4 has one or more blades 41,42 attached to a central shaft 3, whereby said blades 41,42 have a slight upwards bending towards the free outer end edge, whereby the pitch of each blade is greater at its free outer end edge than along the central shaft. (FIG. 4)
The apparatus is provided with supporting legs (71,72,73) to which the supporting element (1) is attached, advantageously in an adjustable manner (see FIGS. 1 and 2).
The legs (71,72,73) are associated to one or more floating elements (75,76,77), whereby advantageously each floating element (75,76,77) is attached to one or more legs by a connecting means enabling to adjust at least partly the position of the floating element with respect to said one or more legs. The legs (71, 72, 73) have substantially the shape of a V vertical profile ending with protuberances 80 directed the one towards the other. The floating elements (75,76,77) have a vertical shape ending with a substantially triangular portion 78 with vertical grooves 78A, said portion 77 being adapted to extend within the V shaped profile, the protuberances 80 of the leg extending in the vertical grooves 78. (see FIG. 5) The position of the floating element 75,76,77 can be adapted with respect to a leg, by sliding the floating element with respect to the leg. The upper portion of the leg is provided with a mobile or removable plate 82, said plate being moved or removed in an open position so as to slide the floating element within the V shaped leg profile. The plate 82 when fixed on the profile of a leg acts as abutment for the floating element, i.e. preventing then the floating element to escape away from the profile. The bottom of the leg is also provided with a abutment 83 so as to limit the downward movement of the floating element with respect to the leg. The relative position of the floating element with respect to the upper plate 82 and the bottom abutment 83, can be fixed by placing one or more abutting elements or spacers 84,85, respectively between the plate and the floating element, and between the bottom abutment and the floating element. The relative position of the floating element with respect to a leg can be adapted by using abutting elements or spacers having different heights. Other fixation means for maintaining a relative position of a floating element with respect to a leg are possible.
The legs and/or the floating element(s) is/are provided with deflectors 88. Said deflectors 88 are protecting element for the legs and floating elements, and act as guiding element for possible liquid flow directed towards the legs. Said deflectors have for example a V-shaped profile and can be associated to one or more guiding plate or fin 88b is, acting also as means for indicating the level position of the deflecting plate 5.
The apparatus is possibly provided with a cover 86 advantageously with a central opening 86A enabling access to the power drive (2) (shown in dashed lines in FIG. 2).
the housing 6 comprises at least a main at least conical portion 6 with a cylindrical part 63 provided with cuts 67 and an upper cylindrical portion 69 mounted mobile with respect to the main portion 6 between at least a first position defining first radial expelling zones for expelling each first volume of expelled liquid, and second radial expelling zones for expelling each second volume of expelled liquid, said second volume of expelled liquid being at least 25% larger than said first volume of expelled liquid through a first radial expelling zones, and a second position defining radial expelling zones different form the first position. The movement of the ring 69 is a rotation movement of the ring 69 along the axis A. The ring 69 is provided with cuts 69A and peaks 69B. By rotating the ring 69, the peaks 69B can close partly the opening 67 of the upper part of the housing 6, whereby enabling to control/adapt the flow of liquid flowing through the openings defined by the valleys 68 associated to the valleys 69A. When the ring 69 closes partly the opening 67, it modifies the total free opening of the passages below the upper edge, and whereby modifying the ratio aeration/mixing of the apparatus (FIG. 9).
Advantageously, the impeller is associated to a means for positioning the intake side of the impeller into the intake cone. The correct position can be adapted by a means modifying the distance between the power drive 2 and the supporting plate 1. Such a means can be a screw mechanism or any other mechanical means. By adapting the position of the bottom portion of the impeller into the intake cone 64, in the portion thereof adjacent to the cylindrical part 63, it means an extra reduction of the impeller length, but meaning also reduction of the risk of blockage with fibers or any other debris, improvement of the centering in the volute or housing, ensuring better and smaller clearance between the volute or housing and the impeller, less vibration of the shaft 3, less power consumption for a same pumping flow rate, reduced weight, etc.
As it can be seen from FIGS. 1 and 2, the power drive 2 is attached to a triangular supporting plate attached to an open triangular supporting structure 100 formed by attaching together three beams 101. The triangular structure defines a substantially equilateral triangle and the opening defines by the said three beams 101 is only partly closed by the plate 1. Said plate 1 is advantageously also triangular shaped (like an equilateral triangle), the top of the plate 1 being each attached at the middle point of a beam 101. Other shapes are possible, like square, pentagon, hexagon, etc., but the triangular shape seems to be the most appropriate for the majority of possible applications, as well as basin or pool geometry/shape. With such an embodiment, the plate 1 is not directly attached to the legs 75,76,77, but only through the beams 101.
The power drive or motor is positioned above the liquid level and is protected from possible splashing by the supporting plate 1, as well as the deflecting plate 5 and disc 8. The position of the power drive with respect to the liquid level and deflecting plate 5 is such that the motor 2 is well protected against any splashing as well as any possible foaming

This way the motor is better protected against damage caused by foam or other material contained in the liquid. Furthermore, thanks to the important distance between the motor support structure and the impeller with volute or housing, there is no spray or liquid flow that can return to the lower motor seal and bearing.
A deflector plate 5 (advantageously circular) or a deflecting disc 8 just above the impeller especially in case of a screw centrifugal type deflects outwardly (centrifugal) the pumped liquid flow laterally or radial with respect to the shaft 3. The impeller top portion advantageously bends the pumped flow to an angle to return to the liquid surface. If necessary, such deflector can add an extra angle to the flow expelled by the top portion of the impeller, said extra angle being then for example determined by the diameter and shape of the deflector. In a possible embodiment, the deflector disc 8 is mounted rotating on the shaft 3, advantageously with a bearing.
The impeller (for example when being a double helixes) has advantageously no central hub.

In case of a screw centrifugal impeller the screw part can be manufactured without central hub to increase the pumped-up flow. To maintain the strength of the screw construction, the blades can be connected at the central line or axis of the impeller.
The structure 100 can be provided with mooring points 105 for attaching the floating structure to mooring cables 110, so to maintain the position of the floating structure with respect to the pool or basin. The mooring points 105 are located distant from the legs advantageously adjacent to the fixing points of the plate 1 on the beam structure 100, whereby the torque of the motor is directly transferred to the mooring cables without applying load on the plastic floats.
The hub or housing 6, especially the conical bottom part 64, is connected to the legs 75,76,77 by plates 120, radial with respect to the shaft 3. Advantageously the deflector 88 reinforcing the legs 75,76,77 is connected the said radial plate 120.
The floats have lateral guiding protuberances 130 extending on the lateral faces.

Said protuberances guide the flow of liquid expelled from the housing 6. Said protuberances (advantageously curved and forming a continuous rib extending on the two opposite lateral faces of the float) form reinforcing ribs (see FIG. 5). The floats of FIGS. 1 and 2 are provided with horizontal ribs 130.
Hydrodynamic floats.

The shape of the floats is preferably hydrodynamic as to minimize obstruction of the spray and induced flow. The floats can have a symmetrical shape or any other shape that is optimal for the operation conditions (see FIG. 6 showing possible cross section of floats).

Depending on the total weight of the apparatus, changing the position of the floats, changing the floating characteristics of the floats (for example by adding some loading elements to one or more floats), will enable to control the desired submergence/position of the volute or housing, with respect to the liquid level.

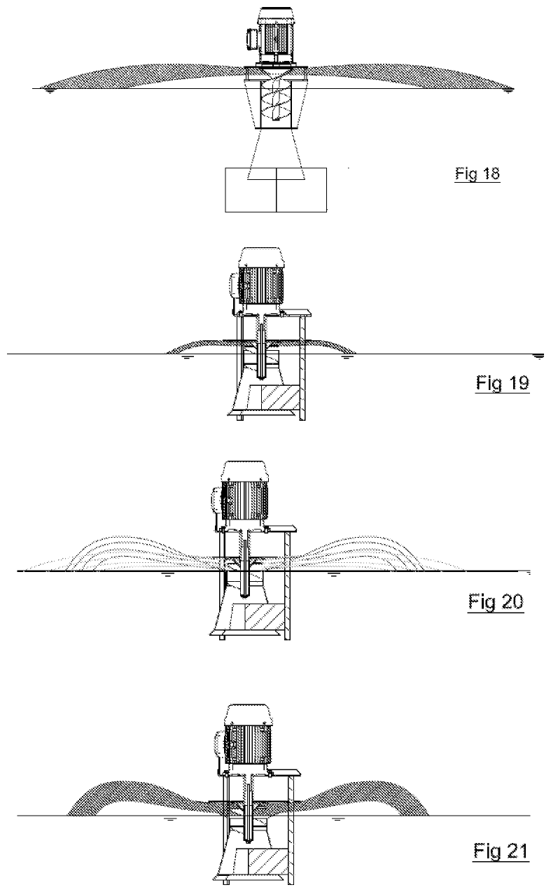

FIGS. 18 to 21 are schematic views of apparatuses not according to the invention, having a volute with a flat and not corrugated, upper edge extending parallel to the liquid body surface.

In FIG. 18, the volute has a flat upper edge and positioned significantly above the liquid surface level for a stable operation as an aerator and consequently with a long screw centrifugal type impeller.

The horizontal and vertical speed component of the spray when contacting the liquid body surface is reduced, meaning a reduced mixing effect at the liquid body surface.

The spray returns far away from the volute back to the liquid surface and part of the induced flow returns to the intake cone.

In FIG. 19, the embodiment is the same as that of FIG. 18, but the impeller is a short impeller. The impeller was unable to pump up the flow at all or eventually a very reduced flow, said liquid being expelled with a very reduced flow speed. No efficient aeration, nor efficient mixing is achieved.

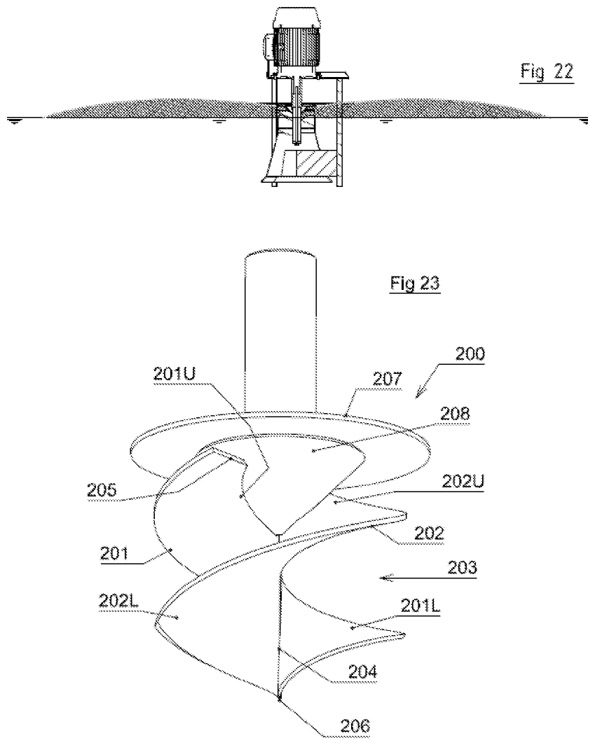

In FIG. 20, (the embodiment is similar to the embodiment of FIG. 19), the volute with the upper flat edge is located so that the upper flat edge is close to (but above) or at the liquid surface or just above the liquid surface. Now, the impeller is able to pump up a full flow. However, a unstable spray was achieved, the spray varying in an uncontrollable way, from flat spray up to high spray, said variation being for example due to the fact that the level of the upper edge or portion thereof is once above the liquid body surface, and once below the liquid body surface. Sometimes, a radial portion of the spray can be flat, while another radial portion is of the high type.

In FIG. 21 (the embodiment is similar to the embodiment of FIG. 19), the volute has its flat upper edge well below the liquid body surface. The radial spray is thicker and higher with less velocity resulting in. Lowering the flat upper edge further down will result in still more mixing and less aeration

FIG. 22 (working according to the invention) is a schematic view of a apparatus similar to that shown in FIGS. 19 to 21, except that the upper edge of the volute or housing is corrugated (4 waves with peak tops level distant from valley bottoms level by a distance of 5 to 20 cm). The peaks are partly above the liquid body surface, while the bottom of the valleys is partly below the liquid body surface, whereby creating preferred radial flat outflow for the spray escaping from the volute or housing. Excellent mixing and aeration were observed, with respect to the embodiments of FIGS. 18 to 21, with even less power consumption with respect to the power consumption in the embodiments of FIGS. 18 to 21.

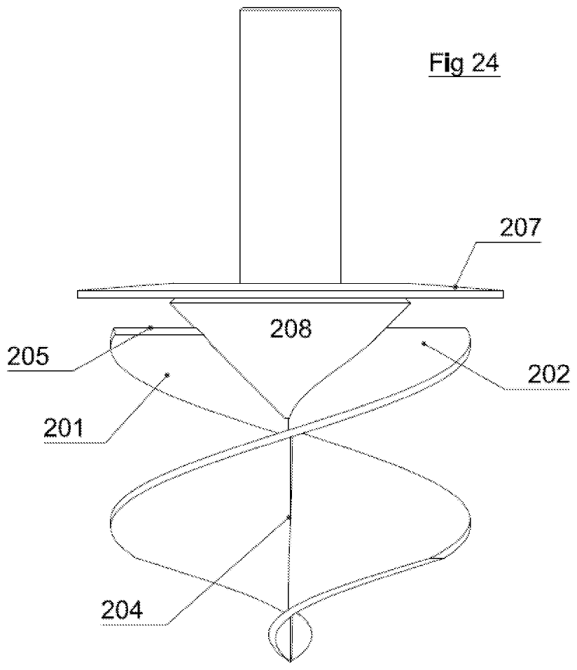

FIGS. 23 and 24 are views of a screw impeller suitable for the apparatus of the invention. It can also be used for other purposes.

The screw centrifugal impeller (200) comprises at least two blades (201,202) forming a screw (203) with a central axis (204) and extending on an axial height between a top end (205) and a bottom end (206), said blades (201,202) having each an upper portion (201U,202U) adjacent to the top end and a lower portion (201L,202L) adjacent to the bottom end, whereby the upper portion (201U,202U) of each blades are attached to a deflector plate or disc (207), with interposition of a central intermediate element (208), while the lower portions (201L,202L) of the blades (201,202) are connected the one to the other along the central axis (204) of the screw.

The upper portions (201U,202U) of the blades are connected to the deflector plate or disc (207) with interposition of a central intermediate element (208), said intermediate element (208) having a conical shape.

The lower portions (201L,202L) of the blades (201,202) are connected the one to the other along the central axis (204) of the screw on a distance equal or greater than 50% of the axial height of the screw.

The upper portions (201U, 202U) of the blades (201,202) are distant from the deflector plate or disc (207) by a distance equal to or greater than 0.5 cm, advantageously greater than 1 cm, preferably from 1 to 10 cm.

The free edges of the blades 201, 202 are located along a cylindrical face.

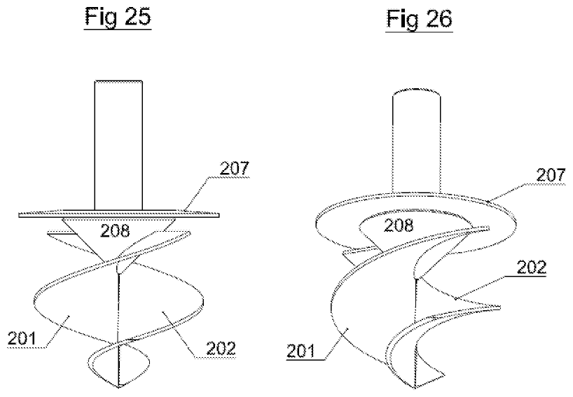

The embodiment of FIGS. 25 and 26 are views of an embodiment similar to the embodiment of FIGS. 23 and 24, except that the bottom end of the screw has edges located along a conical shape.

The invention relates thus also to an improved apparatus for at least mixing a liquid within a liquid body, advantageously for mixing and aerating a liquid within a liquid body, said improved apparatus comprising the improvement that it comprises a screw centrifugal impeller as disclosed as examples only in FIGS. 23 to 26, as well as to the use of such an improved apparatus, for mixing and/or aerating a liquid within a liquid body.

1. An improved apparatus for at least mixing and aerating a liquid within a liquid body with a liquid surface, said apparatus comprising:
a supporting element (1);
a top-mounted power drive (2) mounted on said supporting element (1), said top-mounted power drive (2) having a rotatable shaft (3) extending downwardly toward the liquid surface of said liquid body;
an impeller (4) mounted on said rotatable shaft (3) for rotation therewith;
an at least partly conical housing (6), said housing comprising at least an upper portion (6A) ending with an upper free edge, and a lower portion (6B) ending with a lower free edge, whereby said at least partly conical housing (6) is attached to an element selected from the group consisting of the supporting element (1) and a part attached to the said supporting element (1), whereby said at least partly conical housing (6) defines an inner open channel (6C) between an upper opening and a lower opening, said inner open channel of the at least partly conical housing (6) having substantially a central axis, whereby defining at least a first substantially circular cross section perpendicular to said central axis adjacent to the upper opening and a second substantially circular cross section perpendicular to said central axis of symmetry adjacent to the lower opening, said second substantially circular cross section being greater than the said first substantially circular cross section;
whereby the impeller (4) has at least a lower portion (4B) extending at least partly within the at least partly conical housing (6), and whereby said impeller (4) is adapted so that when driven into rotation by driving into rotation the said rotatable shaft (3), the impeller (4) generates (a) a pumping of liquid within the at least partly conical housing (6) through its lower opening, whereby generating pumped liquid to flow through said at least partly conical housing (6) from the lower opening towards the upper opening, and (b) to expel said pumped liquid through the upper opening of the at least partly conical housing (6), and
whereby the upper free edge of the upper portion (6A) of the at least partly conical housing (6) is a corrugated free upper edge defining peaks and valleys, whereby two successive peaks are separated by a valley, and whereby the distance measured parallel to the central axis of the at least partly conical housing (6) between the top of a peak and the bottom of a valley is greater than or equal to 2 cm.

2. The improved apparatus of claim 1, which further comprises at least one deflecting means selected from the group consisting of a static deflecting plate (5) attached to the supporting element (1), a deflecting disc (8) associated to the impeller, a deflecting disc associated to the rotatable shaft (3), and a combination thereof, and
in which the impeller (4) is a screw centrifugal impeller having an upper portion (4A) extending at least partly outside the upper portion (6A) of the at least partly conical housing (6) above the upper free edge, the said screw centrifugal impeller expelling at least a portion of the pumped liquid towards the deflecting means for deflecting said portion of the pumped fluid.

3. The improved apparatus of claim 2, in which the deflecting means is located at a level above the corrugated free upper edge of the at least partly conical housing (6).

4. The improved apparatus of claim 1, in which the distance measured parallel to the central axis of the at least partly conical housing (6) between the top of a peak and the bottom of a valley of the corrugated free upper edge of the at least partly conical housing (6) is comprised between 5 cm and 50 cm.

5. The improved apparatus of claim 1, in which the corrugated free upper edge has a series of peaks having each a top and a series of valleys having each a bottom, whereby two successive peaks are separated the one from the other by a valley, whereby each top of the said peaks extends within an upper plane perpendicular to the central axis, while each bottom of the said valleys extends within a lower plane perpendicular to the central axis.

6. The improved apparatus of claim 1, in which the at least partly conical housing (6) comprises a substantially cylindrical upper portion provided with a corrugated free upper edge defining peaks and valleys, whereby when developing the said substantially cylindrical upper portion of the at least partly conical housing (6) in a developing plane, the peaks and valleys are at least partly curved.

7. The improved apparatus of claim 1, in which the corrugated free upper edge comprises from 2 to 10 peaks.

8. The improved apparatus of claim 1, in which, when developed within a plane parallel to the central axis of the housing (6), the corrugated free upper edge of the at least partly conical housing (6) follows a substantially sinusoidal line.

9. The improved apparatus of claim 1, in which the at least partly conical housing (6) comprises:
(a) an upper cylindrical part (6A) presenting the corrugated free upper edge of the at least partly conical housing (6), whereby said upper cylindrical part (6A) extends between a top upper plane perpendicular to the central axis of the at least partly conical housing (6), and a lower plane perpendicular to the central axis of the at least partly conical housing (6) and distant from the said top upper plane, and
(b) a lower conical part (6B) attached to the upper cylindrical part (6A), whereby said top upper plane and said lower plane are distant from each other by a distance of at least 10 cm.

10. The improved apparatus of claim 9, in which said top upper plane and said lower plane are distant from each other by a distance comprised between 10 cm and 50 cm.

11. The improved apparatus of claim 1, in which the at least partly conical housing (6) comprises:
(a) an upper cylindrical part (6A) presenting the corrugated free upper edge of the at least partly conical housing (6), whereby said upper cylindrical part (6A) extends between a top upper plane perpendicular to the central axis of the at least partly conical housing (6), and a lower plane perpendicular to the central axis of the at least partly conical housing (6) and distant from the said top upper plane, and
(b) a lower conical part (6B) attached to the upper cylindrical part (6A), whereby said top upper plane and said lower plane are distant from each other by a distance of at least 10 cm,
in which the upper cylindrical part (6A) of the at least partly conical housing (6) has an inner diameter,
in which the impeller (4) has an upper portion (4A) with at least one blade defining at least one helix with a free end edge,
whereby the upper portion (4A) of the impeller (4) has (i) a first part located partly within the upper cylindrical part (6A) of the at least partly conical housing (6), and (ii) a second part located above and outside the said upper cylindrical part (6A) of the at least partly conical housing (6), and
whereby the free end edge of the helix defined by the blade of the first part of said upper portion (4A) of the impeller (4) extends along a substantially cylindrical surface with a diameter corresponding to 0.9 to 0.995 times the inner diameter of the said upper cylindrical part (6A) of the at least partly conical housing (6).

12. The improved apparatus of claim 11, in which the upper portion (4A) of the impeller is selected from the group consisting of an upper portion comprising two blades defining two distinct helixes around the central axis, and an upper portion comprising three blades defining three distinct helixes around the central axis, whereby each helix has a free end edge, and whereby each helix has (i) a first part located partly within the upper cylindrical part (6A) of the at least partly conical housing (6), and (ii) a second part located above and outside the said upper cylindrical part (6A) of the at least partly conical housing (6), and
whereby the free end edge of the first part of each helix extends along a substantially cylindrical surface with a diameter corresponding to 0.9 to 0.995 times the inner diameter of the said upper cylindrical part (6A) of the at least partly conical housing (6).

13. The improved apparatus of claim 11, in which the impeller (4) has a lower portion (4B) extending within the lower conical part (6B) of the at least partly conical housing (6).

14. The improved apparatus of claim 1, in which the impeller (4) is selected from the group consisting of an impeller with one blade defining a helix around the central axis, an impeller with two blades defining two distinct helixes around the central axis, and an impeller with three blades defining three distinct helixes around the central axis, in which each helix has an end edge portion ending with a free end edge;
in which the impeller (4) has an upper portion (4A) extending at least partly within the upper portion (6A) of the at least partly conical housing and at least partly outside the upper portion (6A) of the at least partly conical housing (6), and
in which the end edge portion of each helix extending in the upper portion (4A) of the impeller (4) is shaped to present a reduced thickness towards its free end edge.

15. The improved apparatus of claim 14, in which the end edge portion of each helix extending in the upper portion (4A) of the impeller has a substantially curved cross-section.

16. The improved apparatus of claim 1, which further comprises at least one deflecting means selected from the group consisting of a static deflecting plate (5) attached to the supporting element (1), a deflecting disc (8) associated to the impeller, a deflecting disc associated to the rotatable shaft (3), and a combination thereof, said deflecting means having a circular shape centred with respect to the central axis of the at least partly conical housing (6) and with an outer edge defined by a diameter,
in which the upper opening of the at least partly conical housing (6) has a open circular section defined in a plane perpendicular to the central axis of the at least partly conical housing (6), said open circular section being centred with respect to the central axis and being defined by a diameter;
in which the impeller (4) is a screw centrifugal impeller having an upper portion (4A) extending at least partly outside the upper portion (6A) of the at least partly conical housing (6) above the upper free edge, the said screw centrifugal impeller expelling at least a portion of the pumped liquid towards the deflecting means for deflecting said portion of the pumped fluid, and
in which the diameter defining the outer edge of said deflecting means is at least by 10% greater than the diameter of the said open circular section of the upper opening of the at least partly conical housing (6).

17. The improved apparatus of claim 1, which further comprises at least one deflecting means selected from the group consisting of a static deflecting plate (5) attached to the supporting element (1), a deflecting disc (8) associated to the impeller, a deflecting disc associated to the rotatable shaft (3), and a combination thereof,
in which the impeller (4) is a screw centrifugal impeller having an upper portion (4A) extending at least partly outside the upper portion (6A) of the at least partly conical housing (6) above the upper free edge, the said screw centrifugal impeller expelling at least a portion of the pumped liquid towards the deflecting means for deflecting said portion of the pumped fluid, and
in which said deflecting means has a lower face directed towards the upper portion (4A) of the screw centrifugal impeller, and an upper face opposite to said lower face, said upper face being chamfered.

18. The improved apparatus of claim 1, in which the impeller (4) has at least one blade defining at least one screw path, whereby a top portion of the impeller comprises an upper portion of the at least one blade, said upper portion ending by an upper end, whereby the top portion is a part of the impeller selected from the group consisting of a disc and a part thereof covering the upper end of the at least one blade.

19. The improved apparatus of claim 1, in which the impeller has at least one blade with an inner end edge attached to a central shaft and with an outer free end edge, whereby said at least one blade is defining a screw-like element around the central shaft, whereby the central shaft has a shaft central axis, whereby the said at least one blade has a slight upwards bending towards the outer free end edge, whereby the at least one blade defines a first pitch distance along the central shaft and a second pitch distance along the outer free edge, said first pitch distance and said second pitch distance being measured parallel to the shaft central axis, whereby the second pitch distance is greater than the first pitch distance.

20. The improved apparatus of claim 1, which comprises at least a top outwardly flared system selected from the group consisting of a top outwardly flared portion of the housing (6), a top outwardly flared portion of the impeller (4), and a combination thereof.

21. The improved apparatus of claim 1, which is provided with supporting legs to which the supporting element (1) is attached.

22. The improved apparatus of claim 21, in which the supporting legs are associated to at least one floating element.

23. The improved apparatus of claim 1, which is provided with legs selected from the group consisting of supporting legs and supporting legs associated to a floating element, and which is further provided with at least one deflector selected from the group consisting of deflectors mounted on the supporting legs and deflectors mounted on the floating element.

24. The improved apparatus of claim 1, which is provided with a cover covering substantially completely the apparatus.

25. The improved apparatus of claim 24, in which the cover has a central opening enabling access to the power drive (2).

26. The improved apparatus of claim 1, in which the at least partly conical housing comprises at least a main at least partly conical portion and an upper cylindrical portion (69) mounted mobile with respect to the main portion between a first position defining first radial expelling zones for expelling each first volume of expelled liquid, and second radial expelling zones for expelling each second volume of expelled liquid, said second volume of expelled liquid being at least 25% larger than said first volume of expelled liquid through a first radial expelling zones, and a second position defining radial expelling zones different form the first position.

27. The improved apparatus of claim 1, in which the impeller is a screw impeller with a central axis and with at least one blade defining a screw path without central hub.

28. The improved apparatus of claim 1, which comprises at least two distinct floating means, said float means being each attached to the supporting element (1) by attaching means selected from the group consisting of attaching means attaching in a mobile way the supporting element (1) to the floating means, and attaching means attaching in a removable way the supporting element (1) to the floating means.

29. The improved apparatus of claim 28, in which the floating means have each lateral substantially vertical faces provided with a series of deflecting guiding protuberances.

30. The improved apparatus of claim 1, which comprises supporting vertical legs attached to the supporting element (1), whereby said supporting vertical legs have each a vertical leading edge directed towards the at least partly conical housing (6), and whereby the said supporting vertical legs are each associated to substantially horizontal deflecting plate extending along the vertical leading edge.

31. The improved apparatus of claim 1, in which the impeller is a screw centrifugal impeller (200) comprising at least two blades (201,202) forming a screw (203) with a central axis (204) and extending on an axial height between a top end (205) and a bottom end (206), said blades (201,202) having each an upper portion (201U,202U) adjacent to the top end and a lower portion (201L,202L) adjacent to the bottom end, whereby the upper portion (201U,202U) of each blades are attached to a deflector plate (207), while the lower portions (201L,202L) of the blades (201,202) are connected the one to the other along the central axis (204) of the screw.

32. The improved apparatus of claim 31, in which the upper portions (201U,202U) of the blades are connected to the deflector plate (207) with interposition of a central intermediate element (208).

33. A process for mixing and aerating a liquid within a liquid body, said process using an apparatus for pumping liquid into a vertical at least partly conical housing, so as to form an upwards flow of pumped fluid into the said vertical at least partly conical housing towards an upper opening, and so as to expel said pumped fluid through said upper opening,
in which the apparatus comprises:
a supporting element (1);
a top-mounted power drive (2) mounted on said supporting element (1), said top-mounted power drive (2) having a rotatable shaft (3) extending downwardly toward the liquid surface of said liquid body;
an impeller (4) mounted on said rotatable shaft (3) for rotation therewith;
an at least partly conical housing (6), said housing comprising at least an upper portion (6A) ending with an upper free edge, and a lower portion (6B) ending with a lower free edge, whereby said at least partly conical housing (6) is attached to an element selected from the group consisting of the supporting element (1) and a part attached to the said supporting element (1), whereby said at least partly conical housing (6) defines an inner open channel (6C) between an upper opening and a lower opening, said inner open channel of the at least partly conical housing (6) having substantially a central axis, whereby defining at least a first substantially circular cross section perpendicular to said central axis adjacent to the upper opening and a second substantially circular cross section perpendicular to said central axis of symmetry adjacent to the lower opening, said second substantially circular cross section being greater than the said first substantially circular cross section;
whereby the impeller (4) has at least a lower portion (4B) extending at least partly within the at least partly conical housing (6), and whereby said impeller (4) is adapted so that when driven into rotation by driving into rotation the said rotatable shaft (3), the impeller (4) generates (a) a pumping of liquid within the at least partly conical housing (6) through its lower opening, whereby generating pumped liquid to flow through said at least partly conical housing (6) from the lower opening towards the upper opening, and (b) to expel said pumped liquid through the upper opening of the at least partly conical housing (6), and
whereby the upper free edge of the upper portion (6A) of the at least partly conical housing (6) is a corrugated free upper edge defining peaks and valleys, whereby two successive peaks are separated by a valley, and whereby the distance measured parallel to the central axis of the at least partly conical housing (6) between the top of a peak and the bottom of a valley is greater than or equal to 2 cm,
the said process being characterised in that pumped liquid is expelled from the apparatus in accordance to at least a series of first radial liquid expelling zones and a series of second radial liquid expelling zones, whereby a second radial liquid expelling zone is located between two successive first radial liquid expelling zones, while a first radial liquid expelling zone is located between two successive second radial liquid expelling zones,
whereby the first radial liquid expelling zones are each characterised by at least a first parameter selected from the group consisting of liquid expelling speed, liquid expelling rate per angular section unit, and combination thereof, while the second radial liquid expelling zones are each characterised by at least a first parameter selected from the group consisting of liquid expelling speed, liquid expelling rate per angular section unit, and
wherein the first parameter of the first radial liquid expelling zones differs by at least 10% from the second parameter of the second radial liquid expelling zones.

34. A screw centrifugal impeller (200) comprising at least two blades (201,202) forming a screw (203) with a central axis (204) and extending on an axial height between a top end (205) and a bottom end (206), said blades (201,202) having each an upper portion (201U,202U) adjacent to the top end and a lower portion (201L,202L) adjacent to the bottom end, whereby the upper portion (201U,202U) of each blades are attached to a deflector plate (207), while the lower portions (201L,202L) of the blades (201,202) are connected the one to the other along the central axis (204) of the screw.

35. The screw centrifugal impeller of claim 34, in which the upper portions (201U,202U) of the blades are connected to the deflector plate or disc (207) with interposition of a central intermediate element (208), said intermediate element (208) having a shape selected among the group consisting of a cylindrical shape, a conical shape, a frustoconical shape, and combinations thereof.
